(19) United States
(12) Patent Application Publication
(10) Pub. No.: US 2024/0127564 A1
(43) Pub. Date: Apr. 18, 2024

(54) INTERACTION METHOD AND APPARATUS OF VIRTUAL SPACE, DEVICE, AND MEDIUM

(71) Applicant: Beijing Zitiao Network Technology Co., Ltd., Beijing (CN)

(72) Inventors: Han Wang, Beijing (CN); Yi Xian, Beijing (CN)

(21) Appl. No.: 18/463,135

(22) Filed: Sep. 7, 2023

(30) Foreign Application Priority Data
Oct. 12, 2022 (CN) 202211248830.7

(51) Int. Cl. G06T 19/20

(52) U.S. Cl. CPC G06T 19/20; G06T 2219/2016

(57) ABSTRACT

The present disclosure provides an interaction method and apparatus of a virtual space, a device, and a medium, the method includes: presenting an interaction navigation panel, which includes interaction objects, in a virtual space in response to a wake-up instruction of the virtual space; in response to a triggering operation on an interaction object, determining a target display panel of an interaction page associated with the interaction object; if the target display panel is a close-range panel, waking up the close-range panel and displaying the interaction page on the close-range panel; and if the target display panel is a long-range panel, waking up the long-range panel and displaying the interaction page on the long-range panel. The close-range panel and the long-range panel are configured to display independently and in different positions. The present disclosure can improve the interactivity and flexibility of the user when interacting with the virtual space.

### CROSS-REFERENCE TO RELATED APPLICATION

The present disclosure claims priority of the Chinese Patent Application No. 202211248830.7, filed on Oct. 12, 2022, the entire disclosure of which is incorporated herein by reference as part of the present disclosure.

### TECHNICAL FIELD

Embodiments of the present disclosure relate to the field of human-computer interaction technology, and particularly, to an interaction method and apparatus of a virtual space, a device, and a medium.

### BACKGROUND

With the development of Extended Reality (XR) technology, a XR device is gradually applied to various industries, such as the film and television industry, the education industry, and the e-commerce industry. The XR device refers to a real and virtual combination and human-computer interactive environment generated through computer technology and wearable devices, and is a collective term for Augmented Reality (AR), Virtual Reality (VR), Mixed Reality (MR), and other forms.

In the process of actual use, the user often needs to interact with the interaction panel presented in the virtual space. However, because the current virtual space only presents one interaction panel to the user, the user needs to constantly switch between the interaction pages presented by the interaction panel when using different types of interaction objects, resulting in poor interactivity and flexibility.

### SUMMARY

The embodiment of the present disclosure provides an interaction method and apparatus of a virtual space, a device, and a medium, which can improve the interactivity and flexibility of the user when interacting with the virtual space.

In the first aspect, the embodiments of the present disclosure provide an interaction method of a virtual space, comprising: presenting an interaction navigation panel in the virtual space in response to a wake-up instruction of the virtual space, the interaction navigation panel comprising at least two pending interaction objects; in response to a triggering operation on an interaction object of the pending interaction objects, determining a target display panel of an interaction page associated with the interaction object; if the target display panel is a close-range panel, waking up the close-range panel in the virtual space and displaying the interaction page associated with the interaction object on the close-range panel; and if the target display panel is a long-range panel, waking up the long-range panel in the virtual space and displaying the interaction page associated with the interaction object on the long-range panel, where the close-range panel and the long-range panel are configured to display independently and in different positions.

In the second aspect, the embodiments of the present disclosure provide an interaction apparatus of a virtual space, comprising: a first response module for presenting an interaction navigation panel in the virtual space in response to a wake-up instruction of the virtual space, the interaction navigation panel comprising at least two pending interaction objects; a second response module for, in response to a triggering operation on an interaction object of the pending interaction objects, determining a target display panel of an interaction page associated with the interaction object; a first display module for waking up a close-range panel in the virtual space and displaying the interaction page associated with the interaction object on the close-range panel if the target display panel is the close-range panel; a second display module for waking up a long-range panel in the virtual space and displaying the interaction page associated with the interaction object on the long-range panel if the target display panel is the long-range panel; and the close-range panel and the long-range panel are configured to display independently and in different positions.

In the third aspect, the embodiments of the present disclosure provide an electronic device comprising: a processor and a memory, the memory is used to store computer programs and the processor is used to call and run the computer programs stored in the memory to execute the interaction method of the virtual space as described in the embodiments of the first aspect or various implementations thereof.

In the fourth aspect, the embodiments of the present disclosure provide a computer-readable storage medium for storing computer programs which causes the computer to execute the interaction method of the virtual space as described in the embodiments of the first aspect or various implementations thereof.

In the fifth aspect, the embodiments of the present disclosure provide a computer program product including a program instruction, when the program instruction is run on an electronic device, such that the electronic device executes the interaction method of the virtual space as described in the embodiments of the first aspect or various implementations thereof.

The technical solution disclosed in the embodiments of the present disclosure has at least the following beneficial effects: an interaction navigation panel comprising at least two pending interaction objects is presented in the virtual space in response to a wake-up instruction of the virtual space. When any interaction object of the pending interaction objects in the interaction navigation panel is detected to be triggered, a target display panel of an interaction page associated with the interaction object is determined in response to the triggering operation on the interaction object. If the target display panel is determined to be a close-range panel, the close-range panel in the virtual space is waken up and the interaction page associated with the interaction object is displayed on the close-range panel. If the target display panel is determined to be a long-range panel, the long-range panel in the virtual space is waken up and the interaction page associated with the interaction object is displayed on the long-range panel, the close-range panel and the long-range panel are configured to display independently and in different positions. The present disclosure sets up the long-range panel, the close-range panel, and the interaction navigation panel in the virtual space, so that when the user interacts with the virtual space, different interaction operations are performed by using the interaction objects presented on the interaction navigation panel. Moreover, by determining whether the target display panel of the interaction page associated with the interaction object is the long-range panel or the close-range panel during interaction, the interaction page associated with the interaction object is displayed on the corresponding target display panel, and thus, by presenting different interaction panels to the user, which can meet the interaction needs of the user in different usage scenes, thereby improving the interactivity and flexibility of the user when interacting with the virtual space, and improving the user experience.

### BRIEF DESCRIPTION OF THE DRAWINGS

To clearly illustrate the technical solution of the embodiments of the present disclosure, the drawings required in the description of the embodiments will be briefly described in the following; it is obvious that the described drawings are only some embodiments of the present disclosure. For those skilled in the art, other drawings can be obtained based on these drawings without any inventive work.

FIG. 1 is a schematic flowchart of a first interaction method of a virtual space according to the embodiment of the present disclosure;

FIG. 2a is a schematic diagram of an interaction navigation panel according to the embodiment of the present disclosure;

FIG. 2b is a schematic diagram of another interaction navigation panel according to the embodiment of the present disclosure;

FIG. 2c is a schematic diagram of still another interaction navigation panel according to the embodiment of the present disclosure;

FIG. 2d is a schematic diagram of yet another interaction navigation panel according to the embodiment of the present disclosure;

FIG. 3a is a schematic diagram of displaying a video playback page on a long-range panel according to the embodiment of the present disclosure;

FIG. 3b is a schematic diagram of displaying an instant messaging page on a close-range panel according to the embodiment of the present disclosure;

FIG. 3c is a schematic diagram of displaying different interaction pages on a long-range panel and a close-range panel according to the embodiment of the present disclosure;

FIG. 4 is a schematic flowchart of a second interaction method of a virtual space according to the embodiment of the present disclosure;

FIG. 5a is a schematic diagram of presenting a close-range panel and a close-range virtual input model in a virtual space according to the embodiment of the present disclosure;

FIG. 5b is a schematic diagram of presenting a long-range panel and a long-range virtual input model in a virtual space according to the embodiment of the present disclosure;

FIG. 5c is a schematic diagram of interacting with interaction pages displayed on a long-range panel and a close-range panel according to the embodiment of the present disclosure;

FIG. 5d is a schematic diagram of interacting with a video playback page according to the embodiment of the present disclosure;

FIG. 6a is a schematic diagram of scaling up and adjusting a virtual input model according to the embodiment of the present disclosure;

FIG. 6b is a schematic diagram of scaling down and adjusting a virtual handheld device according to the embodiment of the present disclosure;

FIG. 6c is a schematic diagram of using a virtual input model to input interaction information according to the embodiment of the present disclosure;

FIG. 7 is a schematic flowchart of a third interaction method of a virtual space according to the embodiment of the present disclosure;

FIG. 8 is a schematic diagram of displaying a purchase prompt pop-up window in a virtual space according to the embodiment of the present disclosure;

FIG. 9 is a schematic flowchart of a fourth interaction method of a virtual space according to the embodiment of the present disclosure;

FIG. 10a is a schematic diagram of presenting a security region setting prompt pop-up window in a virtual space provided by the embodiment of the present disclosure;

FIG. 10b is a schematic diagram of presenting a password input prompt pop-up window in a virtual space provided by the embodiment of the present disclosure;

FIG. 11 is a schematic flowchart of a fifth interaction method of a virtual space according to the embodiment of the present disclosure;

FIG. 12a is a schematic diagram of scaling up and adjusting an interaction navigation panel according to the embodiment of the present disclosure;

FIG. 12b is a schematic diagram of scaling down and adjusting an interaction navigation panel according to the embodiment of the present disclosure;

FIG. 13 is a schematic block diagram of an interaction apparatus of a virtual space according to the embodiment of the present disclosure;

FIG. 14 is a schematic block diagram of an electronic device according to the embodiment of the present disclosure; and

FIG. 15 is a schematic block diagram of an electronic device which is an HMD according to the embodiment of the present disclosure.

### DETAILED DESCRIPTION

The technical solutions of the embodiments of the present disclosure will be described clearly and fully understandable in conjunction with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

It should be noted that the terms “first”, “second”, etc. in the description and claims of the present disclosure, as well as the drawings, are used to distinguish similar objects and do not need to be used to describe a specific sequence or order. It should be understood that the data used in this way can be interchanged in appropriate cases so that the embodiments of the present disclosure described here can be implemented in order other than those illustrated or described here. In addition, the terms “comprise/comprising” and “include/including” and any variations thereof are intended to cover a non-exclusive inclusion. For example, a process, method, system, product, or server that includes a series of steps or units, need not be limited to those clearly listed steps or units but may include other steps or units that are not clearly listed or inherent to these processes, methods, products, or devices.

The present disclosure is applicable to human-computer interaction scenes. With the gradual application of the extended reality (XR) device in various industries, the user can achieve various interactions with the interaction panel presented in the virtual space provided by the XR device. However, due to the current virtual space only presenting one interaction panel to the user, the user needs to constantly switch between the interaction pages presented on the interaction panel when using different types of interaction objects, resulting in poor interactivity and flexibility. Based on this, the present disclosure designs a virtual space interaction scheme, which can improve the interactivity and flexibility of the user when interacting with the virtual space, thereby improving the user experience.

In order to facilitate the understanding of embodiments of the present disclosure, before describing each embodiment of the present disclosure, some concepts involved in all embodiments of the present disclosure are first appropriately explained, as follows:
1) Virtual reality (VR), a technology of creating and experiencing the virtual world, computing to generate a virtual environment, is multi-source information (the virtual reality mentioned in the present disclosure comprises at least visual perception, and can also comprise auditory perception, tactile perception, motion perception, and even taste perception, olfactory perception, etc.), achieving the integration of the virtual environment, interactive three-dimensional dynamic vision and simulation of physical behavior, immersing the user in the simulated virtual reality environment, and achieving applications in various virtual environments such as a map, a game, a video, education, healthcare, simulation, collaborative training, a sale, assisted manufacturing, maintenance, and repair.
2) Virtual reality device (VR device), a terminal that achieves virtual reality effects, can usually be provided in the form of glasses, a head mount display (HMD), or contact lenses, for achieving visual perception and other forms of perception. Of course, the form of the virtual reality device is not limited to this and can be further miniaturized or enlarged according to actual needs.

Optionally, the virtual reality device described in the embodiment of the present disclosure may comprise, but is not limited to, the following types:
2.1) PC virtual reality (PCVR) device, uses the PC to perform the calculation related to virtual reality functions and output data, and the external PC virtual reality device uses the data output from the PC to achieve the effect of virtual reality.
2.2) Mobile virtual reality device, supports setting mobile terminals (e.g., a smartphone) in various ways (e.g., a head mount display with a special card slot). By connecting with the mobile terminal through the wired or wireless method, the mobile terminal performs the calculation related to virtual reality functions, and outputs data to the mobile virtual reality device, such as watching the virtual reality video through the application (APP) of the mobile terminal.
2.3) All-in-one virtual reality device, is equipped with a processor that performs the calculation related to virtual reality functions, and thus has independent virtual reality input and output functions, and does not need to be connected to the PC or the mobile terminal, providing a high degree of freedom of use.
3) Augmented reality (AR), a technology that calculates the camera pose parameters of the camera in the real world (or the three-dimensional world or actual world) in real-time during the process of capturing an image by the camera, and adds a virtual element to the images captured by the camera based on the cameras pose parameter. The virtual element comprises but is not limited to: an image, a video, and a 3D model. The goal of AR technology is to connect the virtual world onto the real world for interaction on the screen.
4) Mixed reality (MR), a simulated set that integrates sensory inputs (e.g., virtual objects) created by the computer with sensory inputs from the physical set or their representations. In some MR sets, the sensory inputs created by the computer can adapt to changes in the sensory inputs from the physical set. In addition, some electronic systems for presenting the MR set can monitor the orientation and/or position relative to the physical set, enabling the virtual object to interact with the real object (i.e., physical element from the physical set or its representation). For example, the system can monitor motion to make a virtual plant appear stationary relative to a physical building.
5) Extended reality (XR) refers to all real and virtual combination environments and human-computer interaction generated through computer technology and wearable devices, and comprises various forms such as augmented reality (AR), virtual reality (VR), and mixed reality (MR).
6) Virtual scene, which is a virtual scene that is displayed (or provided) when an application runs on an electronic device. The virtual scene can be a simulated environment of the real world, a semi simulated and semi fictional virtual scene, or a purely fictional virtual scene. The Virtual scene can be any one of a two-dimensional, a 2.5-dimensional, or a three-dimensional virtual scene. The embodiments of the present disclosure do not limit the dimension of the virtual scene. For example, a virtual scene can comprise a sky, a land, an ocean, and the like, and the land can comprise environmental elements such as a desert, a city, and the like. The user can control the virtual object to move in the virtual scene.
7) Virtual object, which is an object that interacts in the virtual scene and is controlled by a user or a robot program (e.g., an artificial intelligence-based robot program), and can remain stationary, move, and perform various behaviors in the virtual scene, such as various characters in a game.

After introducing some concepts involved in the embodiments of the present disclosure, an interaction method of a virtual space provided by the embodiments of the present disclosure is described in detail below in conjunction with the drawings.

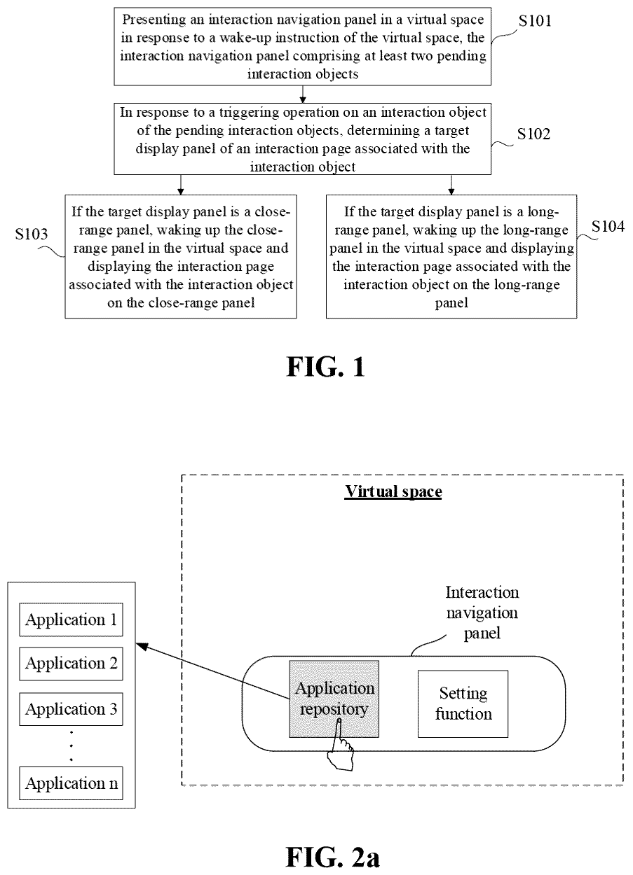

FIG. 1 is a schematic flowchart of an interaction method of a virtual space according to the embodiments of the present disclosure. The embodiments of the present disclosure are applicable to human-machine interaction scenes, and the interaction method of the virtual space may be executed by an interaction apparatus of the virtual space. The interaction apparatus of the virtual space may be composed of hardware and/or software and can be integrated into an electronic device.

In the embodiments of the present disclosure, the electronic device may be any hardware device capable of providing a virtual space to the user. For example, the electronic device may optionally be an XR device or other devices. The XR device may be a VR device, an AR device, or an MR device, and the like, and the present disclosure does not limit the type of the XR device. It should be noted that the present disclosure mainly takes the electronic device as a XR device as an example for further explanation.

As shown in FIG. 1, the method may comprise the following steps:

S101, presenting an interaction navigation panel in a virtual space in response to a wake-up instruction of the virtual space, the interaction navigation panel comprising at least two pending interaction objects.

In the embodiments of the present disclosure, the virtual space is a virtual and real combination environment provided by a XR device to the user. Moreover, the virtual and real combination environment is a virtual environment (virtual space) simulated for a real interaction scene selected by any user. The real interaction scene may be any real environment, such as the concert or the live streaming environment, and the present disclosure does not specifically limit this.

The interaction navigation panel presented in the virtual space is an interaction panel used to provide the user with a plurality of pending interaction objects. Furthermore, the user can use the various pending interaction objects provided by the interaction navigation panel to find the target interaction objects needed in different usage scenes. Moreover, the user can also interact with the target interaction object, and even interact with the virtual space based on the target interaction object.

It should be noted that the pending interaction objects on the interaction navigation panel in the present disclosure comprise different types of applications (software, also known as APP) and various interaction functions. The types of applications may be but are not limited to: social, audio/video, practical life, shopping, and the like; various interaction functions may be but are not limited to: a personal center function, a setting function, and the like, and the present disclosure does not specifically limit these.

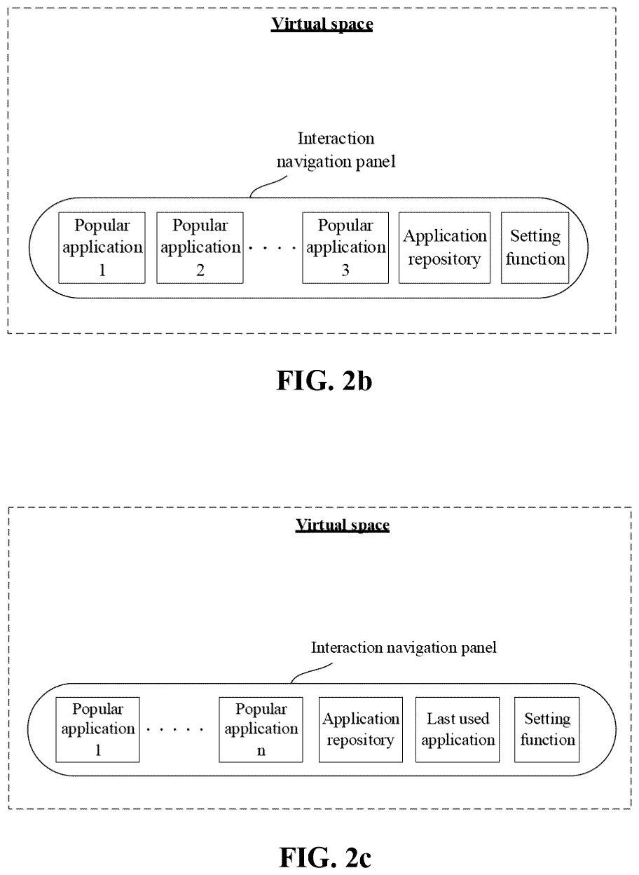

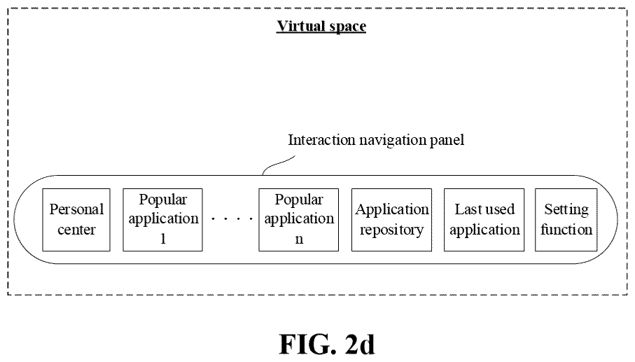

Exemplarily, as shown in FIG. 2a, the pending interaction objects on the interaction navigation panel may comprise: an application repository and a setting function, the application repository comprises all applications installed on the XR device. For example, the system built-in applications, third-party applications downloaded by the user, and the like. Thus, when the user triggers the application repository, all applications located within the application repository can be displayed in the virtual space, allowing the user to select the needed target application from all displayed applications and use the target application.

It should be understood that the present disclosure uses this simplest display method to make the interaction navigation panel presented in the virtual space more concise and compact.

As shown in FIG. 2b, the pending interaction objects on the interaction navigation panel may comprise: a popular application, an application repository, and a setting function, the popular application may be at least one application that the user likes or frequently uses, determined by the XR device through analyzing the user's historical usage data; alternatively, may be at least one application, that is frequently used by the public, determined by conducting social research on the applications, and the like.

It should be noted that in the embodiment, the number of optional popular applications is less than a predetermined value to avoid obstructing other objects presented in the virtual space due to the excessive size of the interaction navigation panel, other objects may be any object that is displayed in the virtual space and is different from the interaction navigation panel. Moreover, the predetermined value may be less than or equal to 5, which can be flexibly set according to actual usage needs, and the present disclosure does not specifically limit the predetermined value herein.

As shown in FIG. 2c, the pending interaction objects on the interaction navigation panel may comprise: a popular application, a last used application, an application repository, and a setting function. By displaying the last used application on the interaction navigation panel, when the user uses the application again, the user can find the desired application without repeatedly searching, thereby improving user efficiency.

As shown in FIG. 2d, the pending interaction objects on the interaction navigation panel may comprise: a personal center function, a popular application, a last used application, an application repository, and a setting function, the personal center function is a function which can support the user to set personal attribute information such as the account information and the account image. By displaying the personal center function on the interaction navigation panel, the present disclosure enables the user to set exclusive information such as the user's own account, image and the like, thereby meeting the personalized usage needs of the user and improving the user's usage satisfaction.

Specifically, when the user uses the XR device, the user may send a wake-up instruction of the virtual space to the XR device through any wake-up method. When the wake-up instruction of the virtual space sent by the user is detected, the XR device wakes up the virtual space based on the wake-up instruction and displays an interaction navigation panel within the virtual space. Displaying the interaction navigation panel within the virtual space specifically comprises waking up the interaction navigation panel from a hidden state so that the user can see the awakened interaction navigation panel. Furthermore, the interaction operation is carried out with the virtual space based on the interaction navigation panel.

It should be noted that, in the present disclosure, the display position of the interaction navigation panel in the virtual space can be any position close to the user's side. Optionally, the interaction navigation panel may be at any position with a distance between 0.6 meters and 0.8 meters from the user's eye. For example, the display position of the interaction navigation panel is a position with a distance of 0.7 meters from the user's eye, and the like. It can be flexibly set according to usage needs, and the present disclosure does not specifically limit the display position of the interaction navigation panel herein.

The present disclosure sends a wake-up instruction of the virtual space to the XR device, which can be achieved through the following method:
Method 1: After starting the XR device, the user can use a handheld device, such as a handle or hand controller, to control the cursor to hover over the wake-up region of the display screen of the XR device. Then, the user can press the confirmation button on the handheld device, such as a trigger button or a grip button, to send a confirmation instruction to the XR device. Thus, a wake-up instruction of the virtual space is sent to the XR device. The wake-up region can be any region of the display screen, which can be flexibly set according to actual application needs, such as a center region, a upper left vertex region, and the like. Moreover, the size of the wake-up region can also be any size, and the present disclosure does not specifically limit this herein.
Method 2: When the XR device is equipped with an eye tracking function, the user can gaze at the wake-up region of the display screen of the XR device after starting the XR device, so that the XR device can determine that the user needs to wake up and enter the virtual space in a case that the duration when the user gazing at the wake-up region reaches the first predetermined duration, the first predetermined duration can be flexibly set according to the usage needs of the eye tracking function, such as 2 seconds(s) or 3 s, and the present disclosure does not specifically limit this herein.
Method 3: After starting the XR device, the user sends the wake-up instruction of the virtual space to the XR device by voice control.
Method 4: After starting the XR device, the user sends the wake-up instruction of the virtual space to the XR device by pressing the wake-up button on the handheld device using the real hand, the wake-up button can be any physical button on the XR device, such as the start button and the like, and the present disclosure does not specifically limit this herein.
Method 5: The user presses the wake-up button on the XR device using the real hand, the wake-up button can be any physical button on the XR device, such as the power-on button, and the present disclosure does not specifically limit this herein.

It should be noted that the above methods of sending the wake-up instruction of the virtual space to the XR device are only exemplary and should not be taken as limitations to the present disclosure.

S102, in response to a triggering operation on an interaction object of the pending interaction objects, determining a target display panel of an interaction page associated with the interaction object. The target display panel comprises a close-range panel and a long-range panel. Moreover, the close-range panel and the long-range panel are configured to display independently and are located in different positions.

Optionally, the display position of the close-range panel may be located at the most comfortable position for the human eye when looking at an object, such as at any position directly in front of the user's eye (perpendicular to the human eye) and with a distance between 0.8 meters (m) and 1.2 m from the user's eye. In the present disclosure, the preferred display position for the close-range panel is the position with a distance of 1 m from the user's eye.

In addition, the display position of the long-range panel is selected as any position located directly in front of the user's eye and with a distance between 2.2 m and 2.6 m from the user's eye. In the present disclosure, the preferred display position for the long-range panel is the position with a distance of 2.4 m from the user's eye. By displaying the long-range panel at the position with a distance of 2.4 m from the human eye, the user experience similar to watching a large laser TV in the real space can be achieved.

Specifically, after presenting the interaction navigation panel in the virtual space, the user can use any triggering method to select and trigger any interaction object (i.e., trigger the target interaction object) from the interaction navigation panel according to the interaction needs. Furthermore, when the XR device detects the user's triggering operation on the target interaction object, in response to the triggering operation, the target display panel of the interaction page associated with the target interaction object is determined.

It should be noted that in the embodiment of the present disclosure, “pending interaction object” represents an object that is presented on the interaction navigation panel and can interact with the user, the “interaction object” (that is, target interaction object) represents an object determined by the user selecting and triggering a certain pending interaction object presented on the interaction navigation panel, that is, the “interaction object” represents any one of all pending interaction objects presented on the interaction navigation panel.

Selecting and triggering the target interaction object from the interaction navigation panel comprises the following scenarios:

Scenario 1

By using a handheld device, controlling the cursor to move to any pending interaction object in the interaction navigation panel and triggering the confirmation button to send the triggering operation of the pending interaction object to the XR device.

If the cursor moves to the pending interaction object of the application repository on the interaction navigation panel and it is detected that the user triggers the confirmation button, the application repository is opened and all applications are displayed on the corresponding interface of the application repository. Furthermore, the user uses the handheld device to control the cursor and select any target application on the corresponding interface of the application repository as the target interaction object, and sends the trigger operation of the target interaction object.

Scenario 2

Sending the triggering instruction to open any interaction object to the XR device through voice control.

For example, sending a voice message such as “Open XX software” to the XR device.

Scenario 3

When the XR device supports the head control function, the user can control the cursor corresponding to the XR device to move to any pending interaction object on the interaction navigation panel by rotating the head to send the triggering operation of the pending interaction object to the XR device.

It is considered that in addition to presenting the interaction navigation panel, optionally a hand model and/or a handheld device model may also be presented in the virtual space. Therefore, when selecting and triggering the target interaction object from the interaction navigation panel and sending the triggering operation of the pending interaction object to the XR device, the present disclosure optionally further comprises: the user controlling the cursor corresponding to the hand model using the handheld device, moving it to any pending interaction object in the interaction navigation panel, and triggering the confirmation button to send the triggering operation of the pending interaction object to the XR device; alternatively, the user using the handheld device to control the cursor corresponding to the handheld device model, moving it to any pending interaction object on the interaction navigation panel, and triggering the confirmation button to send the triggering operation of the pending interaction object to the XR device; alternatively, the user uses the handheld device to control the hand model to grip the handheld device model to move, to control the cursor corresponding to the handheld device model to move to any pending interaction object on the interaction navigation panel, and triggering the confirmation button to send the triggering operation of the pending interaction object to the XR device, and the like.

Furthermore, in the present disclosure, in addition to presenting the interaction navigation panel to the user, the virtual space also presents other panels to the user, such as the close-range panel and the long-range panel, allowing the user to use different panels for human-computer interaction, thereby improving interactivity and flexibility. Therefore, in the present disclosure, in response to a triggering operation on an interaction object of the pending interaction objects, determining a target display panel of an interaction page associated with the triggered target interaction object, specifically comprises: determining a type of the target interaction object and determining the target display panel of the interaction page associated with the target interaction object based on the type of the target interaction object.

As an optional implementation, when determining the type of the target interaction object, the identification information of the target interaction object can be obtained, and then the type of the target interaction object can be determined based on the identification information of the target interaction object. It is considered that the pending interaction objects presented on the interaction navigation panel all have their own identification information, such as name information or icon information, the identification information refers to information that can uniquely determine the identity of the pending interaction object. Therefore, in the present disclosure, obtaining the identification information of the target interaction object can comprise obtaining the name information or icon information of the target interaction object. Furthermore, based on the obtained name information or icon information, from the pre-constructed mapping relationship between the identification information and types, search for the target type that has a mapping relationship with the identification information of the target interaction object. Then, the target type is determined as the type of target interaction object. Alternatively, the present disclosure can also perform big data analysis based on the obtained identification information to determine the target type of the target interaction object and the like, and the present disclosure does not specifically limit this herein.

The pre-constructed mapping relationship between the identification information and types may be a data repository that comprises all the applications and all the interaction functions on the XR device, and the data repository may be an existing repository in the art. Alternatively, the data repository may be a data repository which is individually configured by the manufacturer based on different models of the XR device, and the present disclosure does not specifically limit this herein.

Furthermore, the present disclosure can search for the target display panel of the interaction page associated with the target interaction object in the mapping relationship between the interaction object type and the display panel based on the type of the target interaction object. The mapping relationship between the interaction object type and the display panel is constructed based on the display attributes determined by the type of the interaction object.

Specifically, if the display attribute of the interaction object is determined to be browsing-oriented attribute based on the type of the interaction object, then it is determined that the interaction page associated with the interaction object needs to be displayed on a larger and wider long-range panel. If the display attribute of the interaction object is determined to be non-browsing attribute based on the type of the interaction object, then it is determined that the interaction page associated with the interaction object can be displayed on a regular close-range panel. The browsing-oriented attribute can be understood as the attribute in which the user watches for a long time without performing several operations.

Exemplarily, the mapping relationship between the interaction object type and the display panel in the present disclosure is shown in TABLE 1 below:

TABLE 1

| | Attribute of the | |
|---|---|---|
| Interaction object type | interaction object | Display panel |
| audio or video | browsing-oriented | long-range panel |
| social | non-browsing | close-range panel |
| shopping | browsing-oriented | long-range panel |
| . . . | . . . | . . . |

For example, if it is detected that the target interaction object triggered by the user is an application A1 and the type of the application A1 is video, the application A1 is determined to be a browsing-oriented interaction object based on the video type. Therefore, based on Table 1, it can be determined that the target display panel of the interaction page associated with the application A1 is the long-range panel.

For example, if it is detected that the target interaction object triggered by the user is an application A2, and the type of the application A2 is social, the application A2 is determined to be a non-browsing interaction object based on the social type. Therefore, based on Table 1, it can be determined that the target display panel of the interaction page associated with the application A2 is the close-range panel.

For example, if it is detected that the target interaction object triggered by the user is a setting function, and the type of the setting function is tool, the setting function is determined to be a non-browsing interaction object based on the tool type. Therefore, based on Table 1, it can be determined that the target display panel of the interaction page associated with the setting function is the close-range panel.

In the process of actual use, the user can install new applications on the XR device at any time, or update the system of the XR device to add new interaction functions, that is, adding new pending interaction objects on the interaction navigation panel. However, considering that the predetermined mapping relationship between the interaction object type and the display panel may not be updated in time. Then, when the target interaction object triggered by the user is a new pending interaction object, the present disclosure may not be able to find the target display panel of the interaction page associated with the target interaction object based on the above mentioned mapping relationship between the interaction object type and the display panel.

Therefore, in the mapping relationship between the interaction object type and the display panel in the present disclosure, if the target display panel of the interaction page associated with the target interaction object is not found, it is optional to determine the long-range panel as the target display panel of the interaction page associated with the target interaction object according to a predetermined display rule. This can ensure that the interaction page associated with any interaction object can be displayed normally in the virtual space. The predetermined display rule can be a default display way for the XR device.

That is, when the target display panel of the interaction page associated with any interaction object cannot be found in the mapping relationship between the interaction object type and the display panel, the present disclosure automatically determines the long-range panel as the target display panel of the interaction page associated with the interaction object according to the default display way. Thus, the interaction page associated with any interaction object can be displayed normally in the virtual space, and the user can then perform the interaction operation based on the displayed interaction page.

S103, if the target display panel is a close-range panel, waking up the close-range panel in the virtual space and displaying the interaction page associated with the interaction object on the close-range panel.

S104, if the target display panel is a long-range panel, waking up the long-range panel in the virtual space and displaying the interaction page associated with the interaction object on the long-range panel.

Specifically, when the target display panel of the interaction page associated with the target interaction object is determined to be a close-range panel, the present disclosure wakes up the close-range panel in a hidden state in the virtual space. Furthermore, the interaction page associated with the target interaction object is displayed on the awakened close-range panel.

Alternatively, when the target display panel of the interaction page associated with the target interaction object is determined to be a long-range panel, the present disclosure wakes up the long-range panel in a hidden state in the virtual space. Furthermore, the interaction page associated with the target interaction object is displayed on the awakened long-range panel.

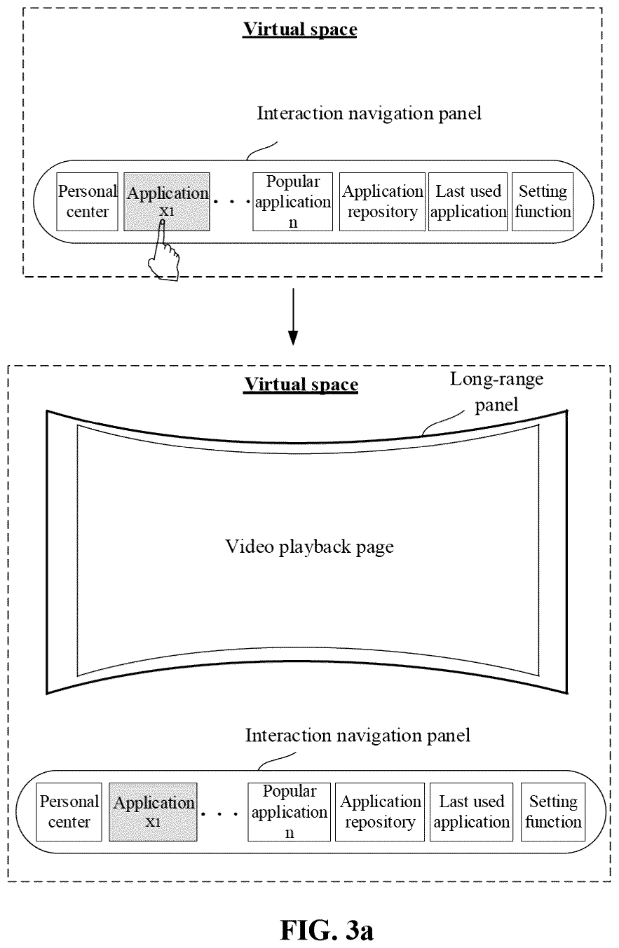

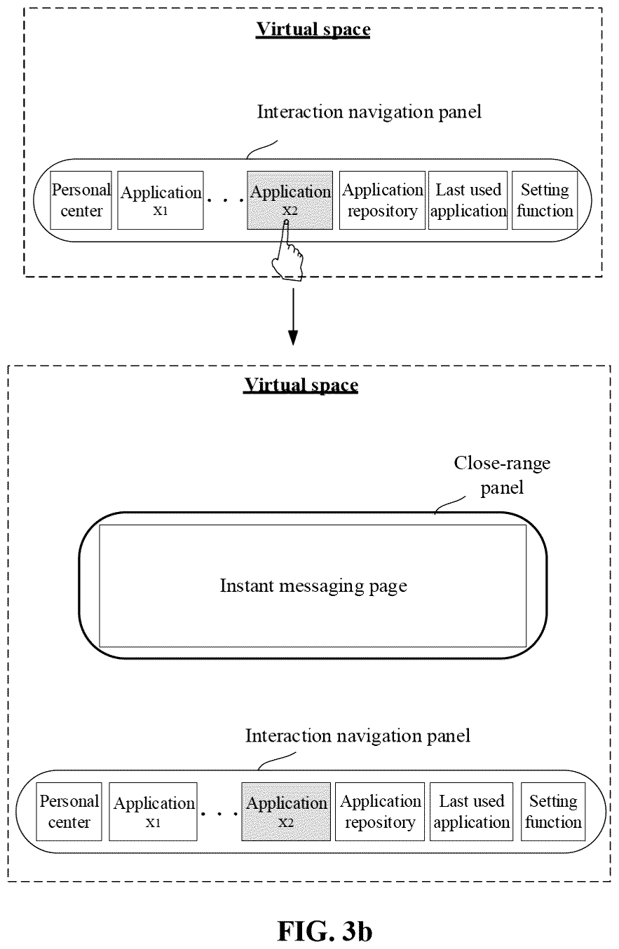

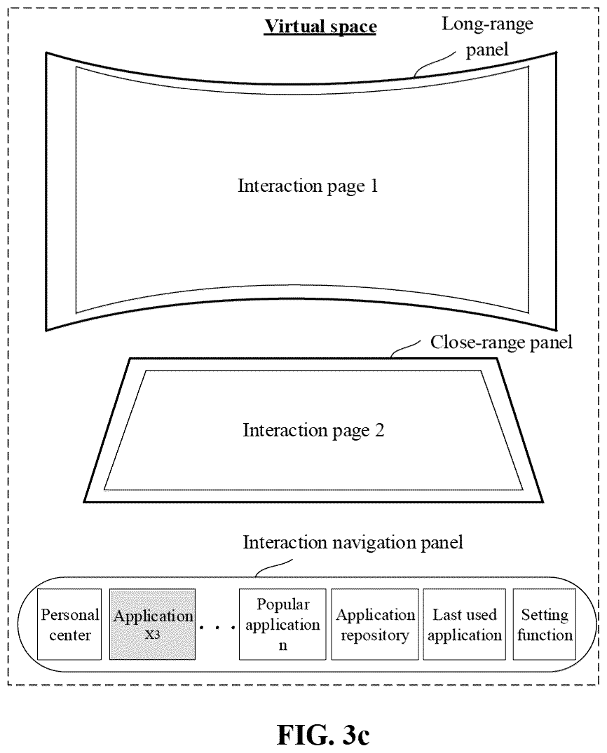

Exemplarily, as shown in FIG. 3a, assuming that the target interaction object is an application X1, and the interaction page associated with the application X1 is a video playback page. When the target display panel of the video playback page is the long-range panel, the long-range panel in a hidden state in the virtual space is waked up. The video playback page is then displayed on the long-range panel.

As shown in FIG. 3b, assuming that the target interaction object is an application X2, and the interaction page associated with the application X2 is an instant messaging page. When the target display panel of the instant messaging page is the close-range panel, the close-range panel in a hidden state in the virtual space is waked up. The instant messaging page is then displayed on the close-range panel.

The interaction method of the virtual space provided in the embodiment of the present disclosure presents an interaction navigation panel, which comprises at least two pending interaction objects, in the virtual space in response to a wake-up instruction of the virtual space; when any interaction object of the pending interaction objects in the interaction navigation panel is detected to be triggered, determines a target display panel of an interaction page associated with the interaction object in response to the triggering operation on the interaction object; if the target display panel is determined to be a close-range panel, wakes up the close-range panel in the virtual space and displays the interaction page associated with the interaction object on the close-range panel, and if the target display panel is determined to be a long-range panel, wakes up the long-range panel in the virtual space and displays the interaction page associated with the interaction object on the long-range panel, the close-range panel and the long-range panel are configured to display independently and are located in different positions. The present disclosure sets up the long-range panel, the close-range panel, and the interaction navigation panel, so that when the user interacts with the virtual space, different interaction operations are performed by using the interaction objects presented on the interaction navigation panel. Moreover, by determining whether the target display panel of the interaction page associated with the interaction object is the long-range panel or the close-range panel during interaction, the interaction page associated with the interaction object is displayed on the corresponding target display panel, and therefore, through presenting different interaction panels to the user, the interaction needs of the user in different usage scenes can be met, thereby improving the interactivity and flexibility of the user when interacting with the virtual space, and ameliorating the user experience.

On the basis of the above embodiment, it is considered that the virtual space can display panels with different display attributes to the user, specifically the long-range panel and the close-range panel. After displaying the interaction page associated with the target interaction object on the close-range panel, the present disclosure further comprises: if any other interaction object in the interaction navigation panel is detected to be triggered and the target display panel of the interaction page associated with the other interaction object is the long-range panel, waking up the long-range panel in the virtual space and displaying the interaction page associated with the other interaction object on the long-range panel.

Alternatively, after displaying the interaction page associated with the interaction object on the long-range panel, the present disclosure further comprises: if any other interaction object in the interaction navigation panel is detected to be triggered and the target display panel of the interaction page associated with the other interaction object is the close-range panel, waking up the close-range panel in the virtual space and displaying the interaction page associated with the other interaction object on the close-range panel.

Exemplarily, as shown in FIG. 3c, after displaying the interaction page 1 associated with a first interaction object on the long-range panel, the interaction page 2 associated with a second interaction object can be displayed on the close-range panel.

That is, the present disclosure can simultaneously display a long-range panel and a close-range panel in the virtual space, in order to use the long-range panel to display an interaction page with a browsing-oriented attribute to the user and to use the close-range panel to display an interaction page with non-browsing attribute to the user, thereby meeting the user's need to use different panels to display interaction pages having different display attributes at the same time. For example, browsing the video screen played on the corresponding interaction page of a video application on the long-range panel, and replying to a friend with the messages in a social application at the same time, and the like. Moreover, because the close-range panel is closer to the user, the user can interact more efficiently and conveniently with the interaction page displayed on the close-range panel, thereby achieving an interaction effect close to the body of the user. In addition, because the long-range panel is away from the user, the interaction page displayed on the long-range panel can provide a broader perspective for the user, which can meet different usage needs of the user in different scenes and further improve the user's visual experience.

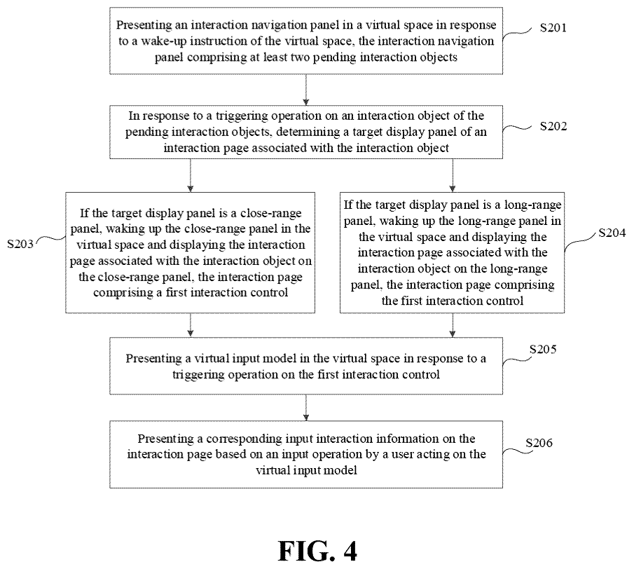

As an optional implementation, it is considered that the interaction page displayed on the close-range panel or the long-range panel can comprise various interaction controls, such as an input control, a like control, or other types of controls. Therefore, after displaying the interaction page associated with the interaction object on the close-range panel or the long-range panel, the user can interact with the interaction page through various interaction controls on the interaction page. The following is a specific explanation of interacting based on a first interaction control on the interaction page in the present disclosure, in conjunction with FIG. 4.

As shown in FIG. 4, the method can comprise the following steps:

S201, presenting an interaction navigation panel in a virtual space in response to a wake-up instruction of the virtual space, the interaction navigation panel comprising at least two pending interaction objects.

S202, in response to a triggering operation on an interaction object of the pending interaction objects, determining a target display panel of an interaction page associated with the interaction object.

S203, if the target display panel is a close-range panel, waking up the close-range panel in the virtual space and displaying the interaction page associated with the interaction object on the close-range panel. The interaction page comprises a first interaction control.

S204, if the target display panel is a long-range panel, waking up the long-range panel in the virtual space and displaying the interaction page associated with the interaction object on the long-range panel. The interaction page comprises the first interaction control.

The close-range panel and the long-range panel are configured to display independently and in different positions.

S205, presenting a virtual input model in the virtual space in response to a triggering operation on the first interaction control.

The first interaction control is specifically an input control. Here, the input control is an information input control.

It should be noted that the virtual input model in the present disclosure may be any type of input model, and the input model is a virtual model constructed in the virtual space based on the real input device. Exemplarily, when the real input device is a keyboard, the virtual input model is correspondingly a virtual keyboard, and the like.

It is considered that the user may need to interact with the interaction page during the process of watching the interaction page displayed on the close-range panel or the long-range panel. For example, the user may need to send a comment message when watching a video, or the user may need to search for a favorite product when viewing products, and the like.

Therefore, the user can trigger the first interaction control located in the interaction page in any way. Moreover, when a triggering operation performed by the user is detected for the first interaction control, it is determined that the user needs to perform an information input operation. At this time, in response to the triggering operation on the first interaction control, waking up the virtual input model in a hidden state and presenting the virtual input model in the virtual space. The method of presenting the virtual input model in the virtual space may be to directly pop up the virtual input model, or to present by using a predetermined animation effect, and the like. The present disclosure does not limit this.

In the embodiment of the present disclosure, the triggering operation performed by the user on the first interaction control may be achieved by using any one of the following methods: a handheld device, a handheld device model, a hand model, eye tracking, and voice, in addition, other methods can also be used, and the present disclosure does not limit this herein.

It is considered that the panel displaying the interaction page in the present disclosure is a long-range panel or a close-range panel, then presenting a virtual input model in the virtual space in response to the triggering operation on the first interaction control, specifically comprises: if the interaction page is displayed on the close-range panel, presenting a close-range virtual input model corresponding to the close-range panel in the virtual space; and if the interaction page is displayed on the long-range panel, presenting a long-range virtual input model corresponding to the long-range panel in the virtual space. The close-range virtual input model and the long-range virtual input model are displayed independently of each other and in different positions.

In the embodiment of the present disclosure, the close-range panel and the long-range panel belong to different display systems. Then, when the close-range virtual input model corresponding to the close-range panel is presented in the virtual space, the target display position of the close-range virtual input model can be determined based on the display position of the close-range panel. Furthermore, the close-range virtual input model is displayed at the target display position of the close-range virtual input model. Similarly, when the long-range virtual input model corresponding to the long-range panel is presented in the virtual space, the target display position of the long-range virtual input model can be determined based on the display position of the close-range panel. Furthermore, the long-range virtual input model is displayed at the target display position of the long-range virtual input model.

In some implementations, the present disclosure may set the target display position of the close-range virtual input model between the user's eye and the close-range panel, with a distance of 0.8 m from the user's eye. Correspondingly, the target display position of the long-range virtual input model may be set between the user's eye and the long-range panel, with a distance of 2.2 m from the user's eye.

It should be understood that the target display position of the close-range virtual input model in the present disclosure can be flexibly adjusted according to the display position of the close-range panel. Similarly, the target display position of the long-range virtual input model can be flexibly adjusted according to the display position of the long-range panel. The present disclosure does not limit this.

Furthermore, the user can interact with the corresponding interaction page based on the virtual input model presented in the virtual space. For example, using the virtual input model for inputting interaction information to achieve the purpose of information interaction.

Because when presenting the close-range virtual input model or the long-range virtual input model in the virtual space, the interaction navigation panel presented in the virtual space may be obstructed by the close-range virtual input model, or the long-range virtual input model may be obstructed by the interaction navigation panel. Therefore, in response to the triggering operation on the first interaction control, the present disclosure optionally hides the interaction navigation panel presented in the virtual space before presenting the close-range virtual input model or the long-range virtual input model in the virtual space.

That is, the present disclosure adjusts the interaction navigation panel in a wake-up state to a hidden state. Therefore, it is possible to avoid the interaction navigation panel in the display state from obstructing the long-range virtual input model, or the displayed close-range virtual input model from obstructing the interaction navigation panel, thereby ensuring the correctness of the display position relationship between the close-range panel and the close-range virtual input model, or between the long-range panel and the long-range virtual input model.

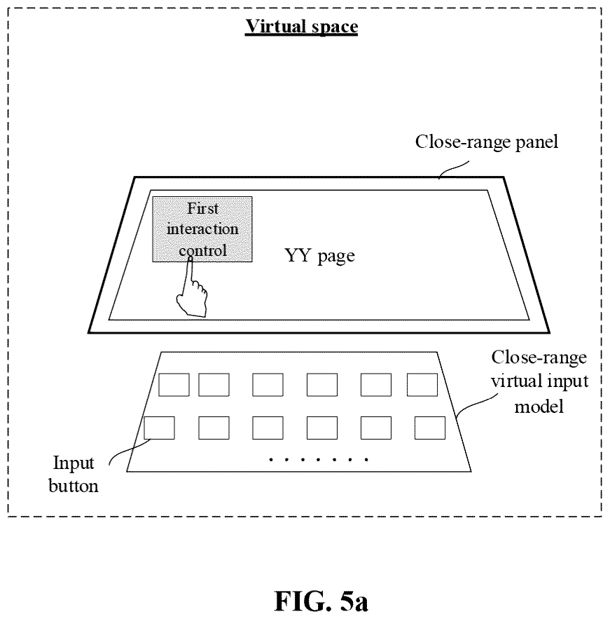

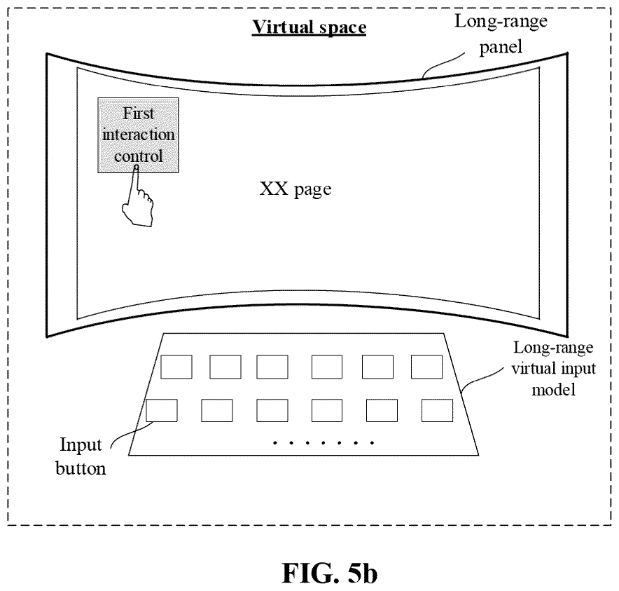

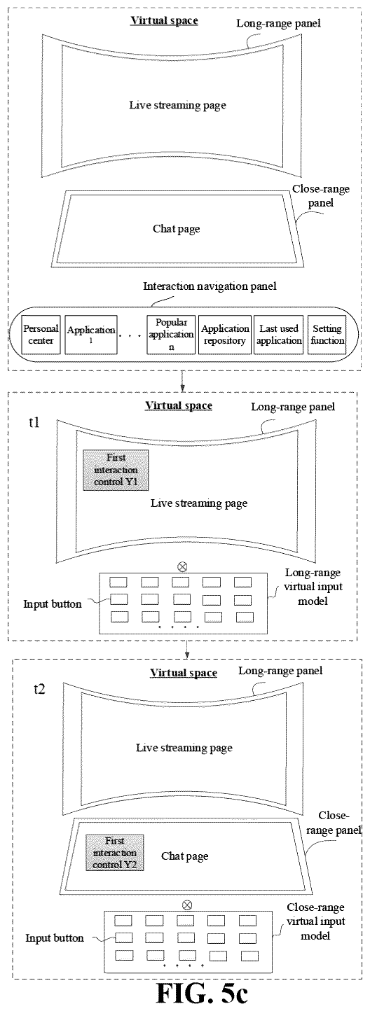

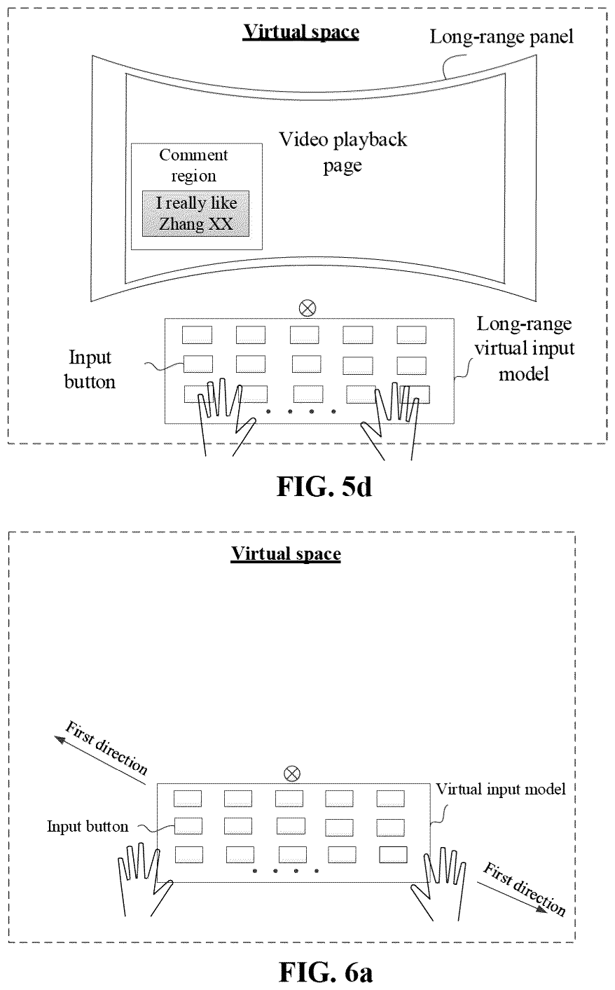

Exemplarily, after hiding the interaction navigation panel, the schematic diagram of presenting a close-range panel and a close-range virtual input model in the virtual space and the schematic diagram of presenting a long-range panel and a long-range virtual input model in the virtual space are shown in FIG. 5a and FIG. 5b. FIG. 5a is the schematic diagram of presenting the close-range panel and the close-range virtual input model in the virtual space; FIG. 5b the schematic diagram of presenting the long-range panel and the long-range virtual input model in the virtual space.

In some implementations, if the long-range panel and the close-range panel display different interaction pages at the same time, and each interaction panel comprises a first interaction control. Then, when the user needs to interact with the displayed interaction page, the present disclosure only allows the user to interact with one of the interaction pages displayed in the long-range panel and the close-range panel. As a result, it avoids the display confusion in the system that may cause the system to crash and exit abnormally.

For example, as shown in FIG. 5c, if a live streaming page is displayed on the long-range panel and a chat page is displayed on the close-range panel, when the user needs to interact with the live streaming page and the chat page, the following steps can be taken:
Step 1: The user triggers the first interaction control Y1 on the live streaming page at first time t1 to wake up the long-range virtual input model in a hidden state in the virtual space. Furthermore, the user interacts with the live streaming page by inputting information based on the long-range virtual input model. When waking up the long-range virtual input model, the close-range panel can be controlled to be in a hidden state to avoid obstructing the long-range virtual input model corresponding to the long-range panel.
Step 2: After the interaction with the live streaming page is completed, the user triggers the first interaction control Y2 on the chat page at second time t2 to wake up the close-range virtual input model in a hidden state in the virtual space. Furthermore, based on the close-range virtual input model, an information interaction is carried out with any user in the chat page. When waking up the close-range virtual input model, the long-range virtual input model can be controlled to be in a hidden state to avoid the long-range virtual input model from being obscured by the close-range panel.
Step 3: After the interaction with the chat page is completed, the user can switch the close-range virtual input model displayed in the virtual space to a hidden state by triggering a close control on the close-range virtual input model to avoid obstructing the content such as the interaction page and the like.

In another implementation, in addition to triggering the close control on the close-range virtual input model to close the close-range virtual input model, the close-range virtual input model may also be automatically closed by monitoring the display duration of the close-range virtual input model in the present disclosure. For example, when the display duration of the close-range virtual input model reaches the predetermined display duration and no user input operation is received, the close-range virtual input model in the display state is automatically switched to a hidden state.

S206, presenting a corresponding input interaction information on the interaction page based on an input operation by a user acting on the virtual input model.

After the virtual input model is presented in the virtual space, the user may use a handheld device, a hand model, or eye tracking or other methods to perform the input operation on the virtual input model. For example, using a handheld device to control the cursor to hover over the target icon and press the confirmation button to input the information corresponding to the target icon; alternatively, the user can use the eyes to gaze at the target icon on the virtual input model for a specified length of time to determine that the user inputs the information corresponding to the target icon. The specified length of time may be flexibly set according to actual application needs, such as 2 s, 3 s, or 5 s, and the present disclosure does not specifically limit the specified length of time. Furthermore, the present disclosure presents the corresponding input interaction information on the interaction page based on the input operation by the user acting on the virtual input model.

In some implementations, the present disclosure presents the corresponding input interaction information on the interaction page based on the input operation by the user acting on the virtual input model, which may comprise the following scenarios:

Scenario 1

Displaying a corresponding text and/or emoticon interaction information in an interaction region of the interaction page based on a text and/or emoticon input operation acting on the virtual input model. The interaction region may be any region on the interaction page that can support information input, such as a comment region or a search box.

For example, as shown in FIG. 5d, if the interaction page is a video playback page and the interaction region is a comment region, then the user uses a hand model to perform the information input operation on the virtual input model, so as to input the comment information “I really like Zhang XX” in the comment input interface of the video playback page, and send the comment information “I really like Zhang XX” to the comment region. Furthermore, the comment information “I really like Zhang XX” input by the user is displayed in the comment region.

Scenario 2

Scaling the virtual input model presented in the virtual space based on a scaling operation acting on the virtual input model. The virtual input models are the long-range virtual input model and the close-range virtual input model.

It is considered that the size of the virtual input model displayed in the virtual space is usually a default value. The default size may not conform to the personal usage habit of the user, for example, the user is accustomed to using a large-sized virtual input model, so that the user can clearly see the buttons on the virtual input model, thus facilitating the input of information. Therefore, the user can scale and adjust the virtual input model based on the usage habit. For example, the virtual input model can be scaled up and down.

The scaling operation acting on the virtual input model in the present disclosure can be achieved by using the handheld device to control the cursor in the operable position of the virtual input model. Then, scaling and adjusting the size of the virtual input model along a direction of stretching or contracting. Of course, the user can also use the hand model or other methods to scale and adjust the size of the virtual input model, and the present disclosure is not limited thereto.

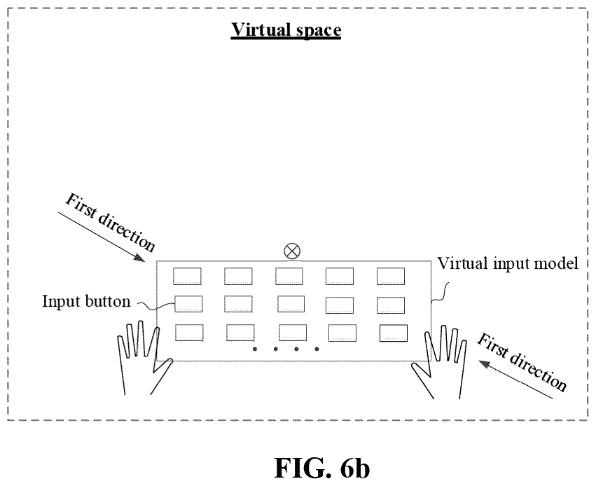

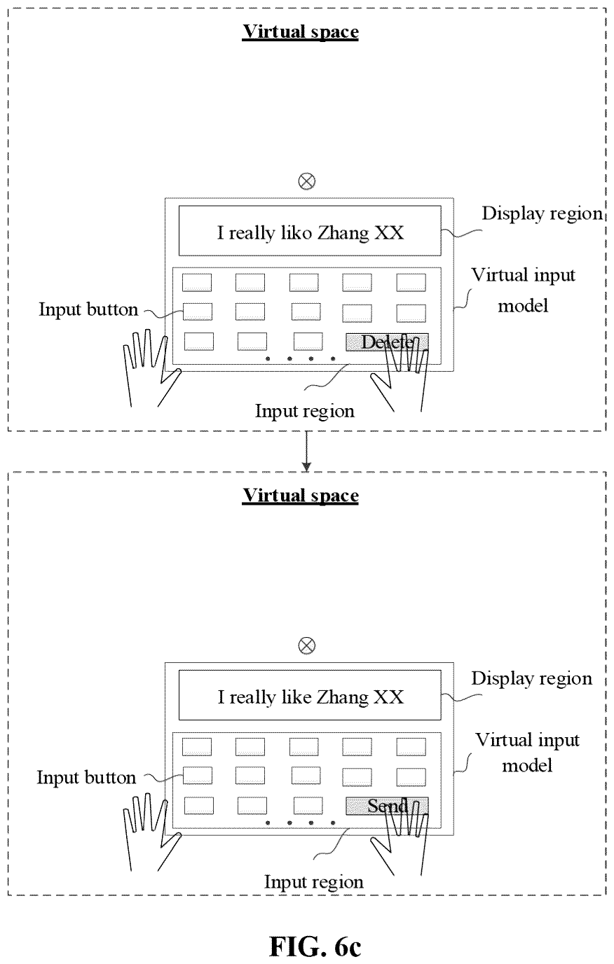

Exemplarily, as shown in FIG. 6a, the user can control the hand model to hold the virtual input model and stretch the virtual input model in the first direction to scale up the virtual input model. Alternatively, as shown in FIG. 6b, the user can control the hand model to hold the virtual input model and shrink the virtual input model in the first direction to scale down the virtual input model. Therefore, by scaling up or down the virtual input model, the user can obtain a virtual input model that conforms to the personal usage habit of the user, making it easy for the user to see the button information on the virtual input model clearly, thereby providing conditions for improving the accuracy of information input.

Furthermore, it is considered that when the user uses the virtual input model to input information, there may be misoperations, resulting in redundant or incorrect information in the input interaction information. Therefore, the present disclosure can set the virtual input model as a model comprising an input region and a display region.

Furthermore, in the present disclosure, presenting a corresponding input interaction information on the interaction page based on an input operation by a user acting on the virtual input model comprises: displaying the corresponding input interaction information in the display region based on the input operation by the user acting on the input region; and displaying the corresponding input interaction information on the interaction page in response to a triggering operation on a sending button in the input region. The advantage of the setting is that based on the input interaction information displayed in the display region, the user can modify the existing redundant or incorrect information, avoiding the operation of revoking and re-editing the interaction information after the interaction information is sent to the interaction page. This can simplify the information input steps and improve the user's information input experience.

Exemplarily, as shown in FIG. 6c, if the interaction information that the user wants to input is “I really like Zhang XX”, then when the input interaction information displayed in the display region of the virtual input model is “I really liko Zhang XX”, it means that there is an error in the input interaction information displayed in the display region. In this case, the user can delete the “liko Zhang XX” in “I really liko Zhang XX” by triggering (pressing) the delete button on the input region of the virtual input model, for example, by clicking the delete button 13 times. Furthermore, re-enter “like Zhang XX”. Then, by triggering (pressing) the send button on the input region of the virtual input model, the correct input interaction information “I really like Zhang XX” is sent to the interaction page, and the input interaction information “I really like Zhang XX” is displayed on the interaction page.

The interaction method of the virtual space provided in the embodiment of the present disclosure sets up the long-range panel, the close-range panel, and the interaction navigation panel, so that when the user interacts with the virtual space, different interaction operations are performed by using the interaction objects presented on the interaction navigation panel. Moreover, by determining whether the target display panel of the interaction page associated with the interaction object is the long-range panel or the close-range panel during interaction, the interaction page associated with the interaction object is displayed on the corresponding target display panel, and therefore, through presenting different interaction panels to the user, the interaction needs of the user in different usage scenes can be met, thereby improving the interactivity and flexibility of the user when interacting with the virtual space, and improving the user experience. In addition, by presenting a virtual input model in the virtual space in response to the triggering operation performed by the user on the first interaction control on the interaction page, the user can send the input interaction information to the interaction page based on the virtual input model, in order to use the input interaction information to interact with the interaction page, thereby achieving the same input operation experience as in the real space and improving the human-computer interaction effect.

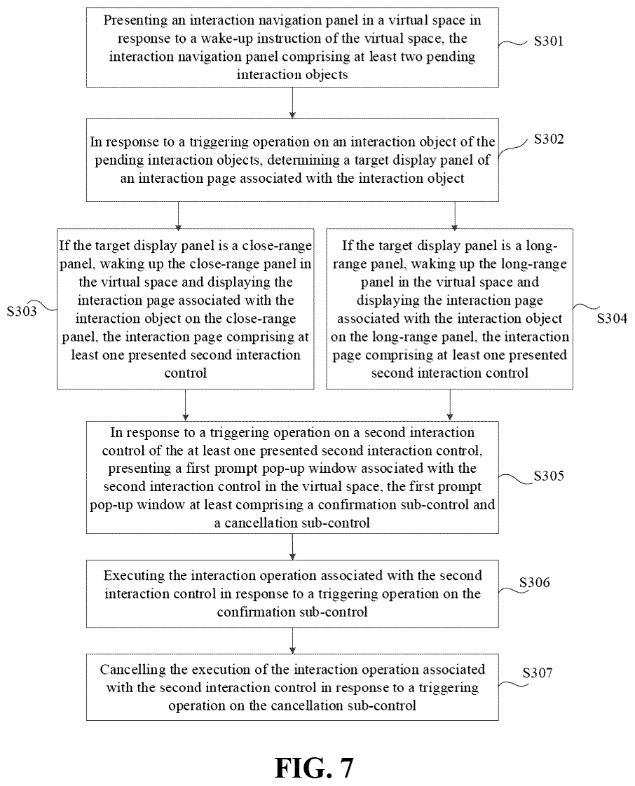

On the basis of the above embodiments, the method of interacting with the interaction page based on the second interaction control on the interaction page in the present disclosure is further described, as shown in FIG. 7.

As shown in FIG. 7, the method may comprise the following steps:

S301, presenting an interaction navigation panel in a virtual space in response to a wake-up instruction of the virtual space, the interaction navigation panel comprising at least two pending interaction objects.

S302, in response to a triggering operation on an interaction object of the pending interaction objects, determining a target display panel of an interaction page associated with the interaction object.

S303, if the target display panel is a close-range panel, waking up the close-range panel in the virtual space and displaying the interaction page associated with the interaction object on the close-range panel, the interaction page comprising at least one presented second interaction control.

S304, if the target display panel is a long-range panel, waking up the long-range panel in the virtual space and displaying the interaction page associated with the interaction object on the long-range panel, the interaction page comprising at least one presented second interaction control.

The close-range panel and the long-range panel are configured to display independently and in different positions.

It should be noted that the second interaction control displayed on the close-range panel or the long-range panel in the present disclosure may be any other interaction control, the operation of which needs to be confirmed by the user, except for the first interaction control. For example, a purchase control, an update control, a recording control, and the like.

In addition, respective second interaction controls in the present disclosure correspond to different interaction functions. For example, when the second interaction control is a purchase control, the purchase control corresponds to the purchase interaction function; when the second interaction control is an update control, the update control corresponds to the update interaction function, and the like. The present disclosure is not limited thereto.

S305, in response to a triggering operation on a second interaction control of the at least one presented second interaction control, presenting a first prompt pop-up window associated with the second interaction control in the virtual space, the first prompt pop-up window at least comprising a confirmation sub-control and a cancellation sub-control.

It should be noted that in the embodiment of the present disclosure, “presented second interaction control” represents other interaction controls presented on the interaction page, except for the first interaction control, the “second interaction control” represents an interaction control determined by the user triggering a certain presented second interaction control presented on the interaction page, that is, the “second interaction control” represents any one of all presented second interaction controls presented on the interaction page.

Specifically, the user may need to interact with the interaction page while viewing an interaction page displayed on a close-range panel or a long-range panel. For example, when viewing a shopping page, the user may need to purchase a certain product, or when watching a video, the user may need to switch the video display mode, and the like.

Therefore, the user may trigger any second interaction control in the interaction page in any way to execute the interaction function corresponding to the second interaction control on the interaction page. Furthermore, when a triggering operation performed by the user on any second interaction control is detected, it is determined that the user needs to perform the interaction action. For example, when the purchase control is triggered, it is determined that the user needs to perform the purchase operation, and the like. At this point, in response to the triggering operation on the triggered second interaction control, the first prompt pop-up window associated with the second interaction control is presented in the virtual space.

In the embodiments of the present disclosure, the first prompt pop-up window may be popped up directly, or may be displayed using a predetermined animation effect, and the present disclosure does not limit this.

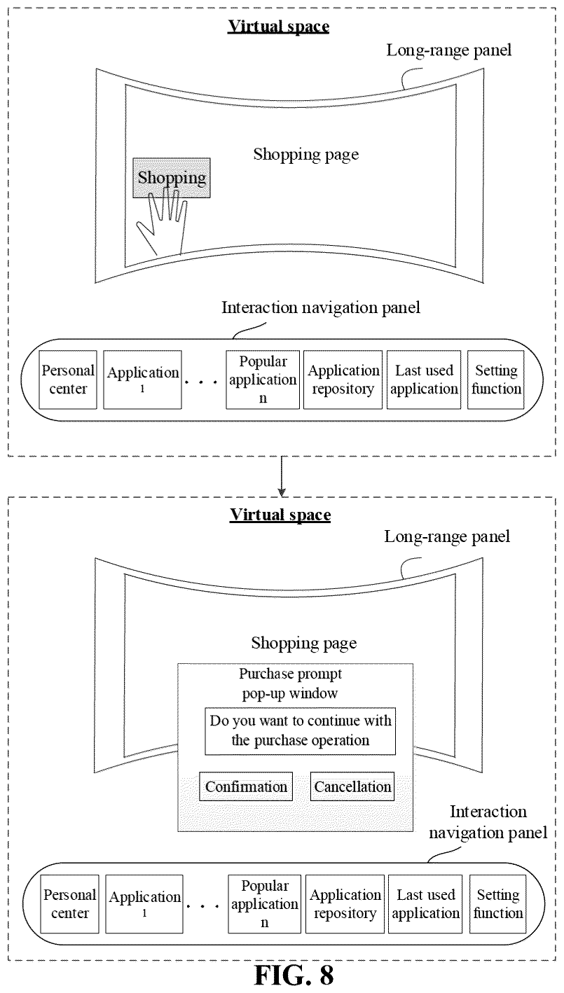

Exemplarily, as shown in FIG. 8, if it is detected that the user triggers the purchase control on the shopping page, the purchase prompt pop-up window associated with the purchase control is displayed in the virtual space. The purchase prompt pop-up window displays a prompt message of “Do you want to continue with the purchase operation”, the purchase confirmation sub-control, and the purchase cancellation sub-control.

It is considered that the panel displaying the interaction page in the present disclosure is a long-range panel or a close-range panel, in the present disclosure, presenting the first prompt pop-up window associated with the second interaction control in response to the triggering operation on any second interaction control specifically comprises: if the interaction page is displayed on the close-range panel, displaying the first prompt pop-up window associated with the second interaction control at a first predetermined position between the close-range panel and the interaction navigation panel presented in the virtual space in response to the triggering operation on any second interaction control; and if the interaction page is displayed on the long-range panel, displaying the first prompt pop-up window associated with the second interaction control at a second predetermined position between the long-range panel and the interaction navigation panel presented in the virtual space in response to the triggering operation on any second interaction control.

In the embodiments of the present disclosure, the close-range panel and the long-range panel belong to different display systems. When displaying the first prompt pop-up window associated with the second interaction control at the first predetermined position between the close-range panel and the interaction navigation panel presented in the virtual space, the first prompt pop-up window can be displayed at any position near the close-range panel. Similarly, when displaying the first prompt pop-up window associated with the second interaction control at the second predetermined position between the long-range panel and the interaction navigation panel presented in the virtual space, the first prompt pop-up window can be displayed at any position near the long-range panel.

In some implementations, the present disclosure may set the first predetermined position between the user's eye and the close-range panel, with a distance of 0.9 m from the user's eye. Correspondingly, the second predetermined position may be set between the user's eye and the long-range panel, with a distance of 2.3 m from the user's eye.

Of course, the first predetermined position and the second predetermined position can also be other positions, which can be flexibly set according to actual application needs, and the present disclosure does not limit this. For example, the first predetermined position is between the user's eye and the close-range panel, with a distance of 0.95 m from the user's eye; and the second predetermined position is between the user's eye and the long-range panel, with a distance of 2.35 m from the user's eye, and the like.

S306, executing the interaction operation associated with the second interaction control in response to a triggering operation on the confirmation sub-control.

S307, cancelling the execution of the interaction operation associated with the second interaction control in response to a triggering operation on the cancellation sub-control.

Based on the example shown in FIG. 8 for illustration, after presenting the purchase prompt pop-up window associated with the purchase control in the virtual space, if the user needs to perform the purchase operation, the user can use the handheld device to control the cursor to hover over the purchase confirmation sub-control and press the confirmation button such as the trigger button to send the confirmation instruction to the XR device. Furthermore, the XR device switches the shopping page to a payment page based on the received confirmation instruction, allowing the user to perform a payment operation. If the user does not want to perform the purchase operation, the user uses the handheld device to control the cursor to hover over the purchase cancellation sub-control and press the confirmation button to send a cancellation instruction to the XR device. Furthermore, the XR device hides the purchase prompt pop-up window based on the received cancellation instruction.

In some implementations, after displaying the first prompt pop-up window associated with the second interaction control to the user, if it is determined that the display duration of the first prompt pop-up window reaches the duration threshold but no operation triggered by the user is detected, it is determined that the user continues to perform the interaction function associated with the second interaction control. The display duration can be flexibly set according to the display requirement of the pop-up window, such as 10 s or 15 s, and the present disclosure does not specifically limit the display duration.

For example, when a purchase prompt pop-up window is displayed to the user and the display duration of the purchase prompt pop-up window reaches the duration threshold of 15 seconds, and no purchase confirmation operation or purchase cancellation operation triggered by the user is detected, it is defaulted that the user needs to perform the purchase operation. At this point, the shopping page is switched to a payment page, allowing the user to perform the payment operation.

The interaction method of the virtual space provided in the embodiment of the present disclosure sets up the long-range panel, the close-range panel, and the interaction navigation panel, so that when the user interacts with the virtual space, different interaction operations are performed by using the interaction objects presented on the interaction navigation panel. Moreover, by determining whether the target display panel of the interaction page associated with the interaction object is the long-range panel or the close-range panel during interaction, the interaction page associated with the interaction object is displayed on the corresponding target display panel, and therefore, through presenting different interaction panels to the user, the interaction needs of the user in different usage scenes can be met, thereby improving the interactivity and flexibility of the user when interacting with the virtual space, and improving the user experience. In addition, by presenting the first prompt pop-up window associated with the second interaction control in the virtual space in response to the triggering operation performed by the user on any second interaction control on the interaction page, allowing the user to confirm whether to continue executing the interaction function corresponding to the second interaction control based on the prompt information provided by the first prompt pop-up window, which avoids the accidental triggering of any interaction operation due to the user's misoperation, and thus can reduce the inconvenience caused by misoperation to the user.

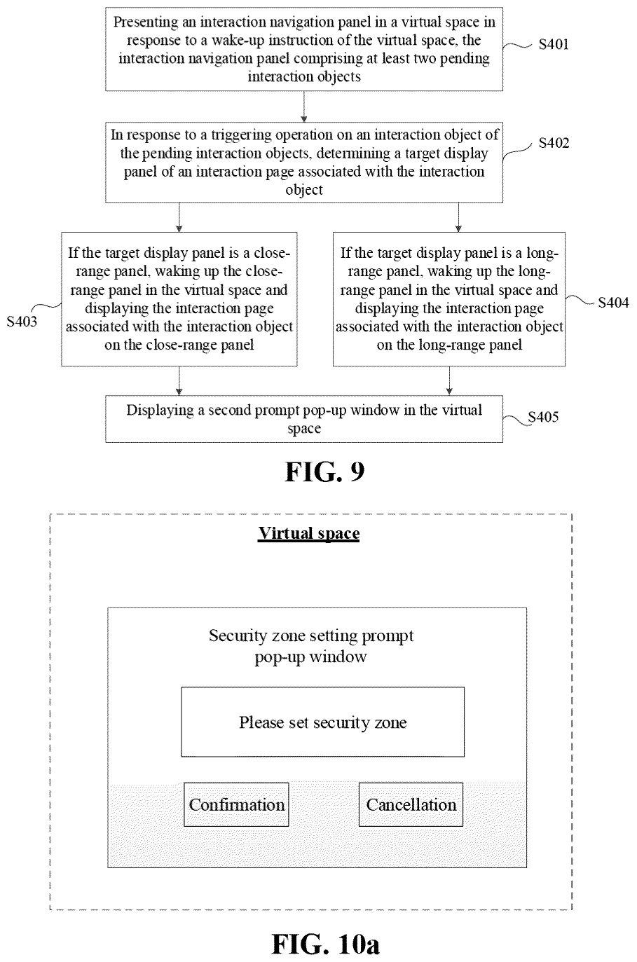

In another implementation, it is considered that during the use of the XR device, the system on the device can display a system side prompt pop-up window in the virtual space based on the action of the user or the predetermined detection mechanism. Furthermore, the user performs the corresponding operation based on the system side prompt pop-up window to ensure that the XR device can work normally. The process of displaying a system side prompt pop-up window in the virtual space provided by the embodiment of the present disclosure is described below in conjunction with FIG. 9.

As shown in FIG. 9, the method may comprise the following steps:

S401, presenting an interaction navigation panel in a virtual space in response to a wake-up instruction of the virtual space, the interaction navigation panel comprising at least two pending interaction objects.

S402, in response to a triggering operation on an interaction object of the pending interaction objects, determining a target display panel of an interaction page associated with the interaction object.

S403, if the target display panel is a close-range panel, waking up the close-range panel in the virtual space and displaying the interaction page associated with the interaction object on the close-range panel.

S404, if the target display panel is a long-range panel, waking up the long-range panel in the virtual space and displaying the interaction page associated with the interaction object on the long-range panel.

The close-range panel and the long-range panel are configured to display independently and in different positions.

S405, displaying a second prompt pop-up window in the virtual space.

The second prompt pop-up window is displayed in front of the close-range panel. That is, the display position of the second prompt pop-up window may be any position between the interaction navigation panel and the user's eye. Exemplarily, assuming that the display position of the interaction navigation panel is a position with a distance of 0.7 m from the user's eye, the display position of the second prompt pop-up window may be any position with a distance less than 0.7 m.

It is considered that when the display position of the second prompt pop-up window is too close to the user's eye, it may cause the user to be unable to see the entire display content of the second prompt pop-up window clearly. Therefore, the present disclosure may select the display position of the second prompt pop-up window to be a position that is between the interaction navigation panel and the user's eye and where the user's eye can see the entire second prompt pop-up window clearly and completely. Optionally, the display position of the second prompt pop-up window is a position with a distance of 0.6 m or 0.65 m, and the like, and the present disclosure does not limit this. That is, the present disclosure sets the second prompt pop-up window at any position close to the interaction navigation panel to ensure that the user can see the entire display content on the second prompt pop-up window clearly.

It should be understood that the second prompt pop-up window in the embodiments of the present disclosure refers to the system prompt information actively sent to the user by the system side based on the operation of the user or the predetermined detection mechanism. The system prompt information can be understood as a global prompt information (global pop-up window).

Usually, when the user uses the XR device, the system side of the XR device automatically performs a series of detection mechanisms; alternatively, judges different operations triggered by the user. Then, based on the results of the detection or judgment, the system side determines whether the system prompt information needs to be sent to the user. The detection mechanism may be detecting the remaining power of the XR device, detecting whether the user has set up a security zone, or detecting whether the identity of the user is legal, and the like. The specific detection mechanism can be flexibly set according to actual usage needs, and the present disclosure does not specifically limit the detection mechanism.

When it is detected that the system prompt information needs to be sent to the user, the system prompt information is displayed in the virtual space through the second prompt pop-up window. Furthermore, it enables the user to perform the corresponding operation based on the system prompt information. For example, if the system prompt information is “Low battery, please charge in time”, the user can charge the XR device based on the message “Low battery, please charge in time”, and the like.

Specifically, in the present disclosure, displaying the second prompt pop-up window in the virtual space can comprise at least one of the following: displaying a security zone setting prompt pop-up window in the virtual space in response to a detection of a security zone setting instruction; displaying an authentication prompt pop-up window in the virtual space in response to a detection of an authentication instruction; and displaying a power prompt pop-up window in the virtual space upon battery power being detected to be lower than a predetermined threshold.

Of course, in addition to the above items, other items can also be comprised, and the present disclosure does not limit this.

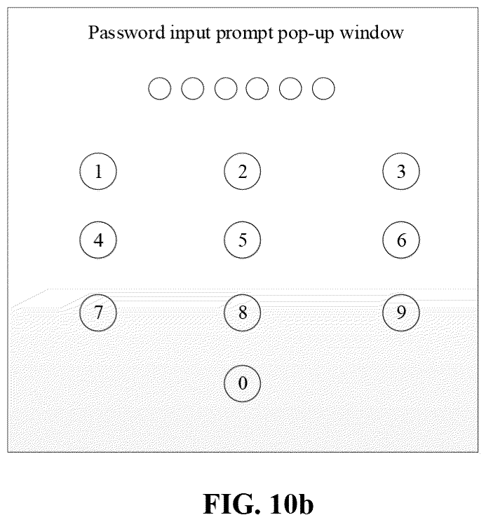

Exemplarily, as shown in FIG. 10a, after the user starts the XR device and enters the virtual space, the XR device can determine, based on the operation of entering the virtual space, that a security zone setting instruction is detected. Then, a security zone setting prompt pop-up window with a prompt message such as “Please set security zone” is displayed in the virtual space. If it is detected that the user has triggered the confirmation control on the security zone setting prompt pop-up window, entering the security zone setting function.

As shown in FIG. 10b, when the user triggers the unlock key of the XR device, the XR device can determine, based on the trigger operation, that the authentication instruction is detected. In this case, a password input prompt pop-up window is displayed in the virtual space. If the authentication password entered by the user is received and verified to be correct, the unlock operation is performed.

The interaction method of the virtual space provided in the embodiment of the present disclosure sets up the long-range panel, the close-range panel, and the interaction navigation panel, so that when the user interacts with the virtual space, different interaction operations are performed by using the interaction objects presented on the interaction navigation panel. Moreover, by determining whether the target display panel of the interaction page associated with the interaction object is the long-range panel or the close-range panel during interaction, the interaction page associated with the interaction object is displayed on the corresponding target display panel, and therefore, through presenting different interaction panels to the user, the interaction needs of the user in different usage scenes can be met, thereby improving the interactivity and flexibility of the user when interacting with the virtual space, and improving the user experience. In addition, by displaying the second prompt pop-up window in the virtual space, the user can perform the corresponding operation based on the second prompt pop-up window to ensure that the user can use the electronic device normally, thereby providing conditions for the user to use the electronic device normally.

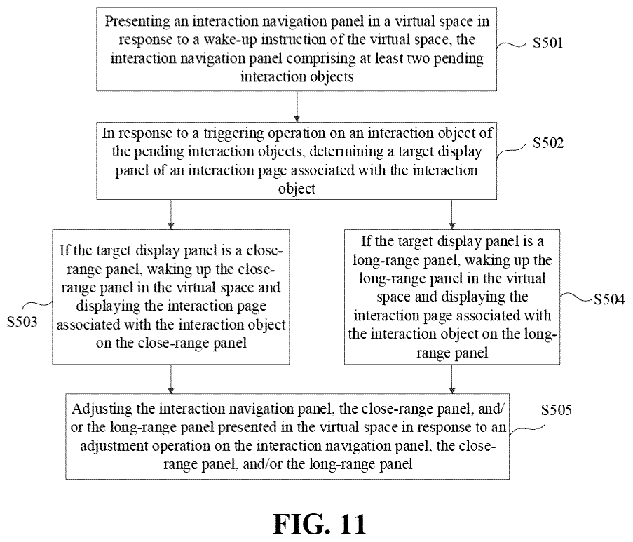

In another implementation, considering that the interaction navigation panel, the close-range panel, and/or the long-range panel presented in the virtual space may not meet the user's usage needs. Therefore, the present disclosure can also make personalized adjustments to the interaction navigation panel, the close-range panel, and/or the long-range panel presented in the virtual space based on the adjustment operation triggered by the user to meet the user's personalized needs. The process of adjusting the interaction navigation panel, the close-range panel, and/or the long-range panel presented in the virtual space provided by the embodiments of the present disclosure is described in conjunction with FIG. 11.

As shown in FIG. 11, the method may comprise the following steps:

S501, presenting an interaction navigation panel in a virtual space in response to a wake-up instruction of the virtual space, the interaction navigation panel comprising at least two pending interaction objects.

S502, in response to a triggering operation on an interaction object of the pending interaction objects, determining a target display panel of an interaction page associated with the interaction object.

S503, if the target display panel is a close-range panel, waking up the close-range panel in the virtual space and displaying the interaction page associated with the interaction object on the close-range panel.

S504, if the target display panel is a long-range panel, waking up the long-range panel in the virtual space and displaying the interaction page associated with the interaction object on the long-range panel. The close-range panel and the long-range panel are configured to display independently and in different positions.

S505, adjusting the interaction navigation panel, the close-range panel, and/or the long-range panel presented in the virtual space in response to an adjustment operation on the interaction navigation panel, the close-range panel, and/or the long-range panel.

For example, considering that if the display sizes of the interaction navigation panel, the close-range panel, and/or the long-range panel presented in the virtual space are too small or too large, it can cause the user to be unable to see clearly the interaction object on the interaction navigation panel, the interaction page displayed on the close-range panel, or the interaction page displayed on the long-range panel. Therefore, the presented interaction navigation panel, close-range panel, and/or long-range panel need to be adjusted so that the user can obtain the interaction navigation panel, the close-range panel, and/or the long-range panel that meet the usage needs of the user.

Specifically, the user can adjust the presented interaction navigation panel, close-range panel, and/or long-range panel by performing the adjustment operation. The adjustment operation can be triggered by the handheld device, the hand model, the handheld device model, or other approaches, and the present disclosure does not limit this.

In the embodiments of the present disclosure, the adjustment operation on the interaction navigation panel, the close-range panel, and/or the long-range panel comprises at least one of the following: scaling adjustment operation, orientation adjustment operation, and region adjustment operation.

The scaling adjustment operation refers to adjusting the size of the interaction navigation panel, the close-range panel, and/or the long-range panel, such as scaling down or scaling up.

The orientation adjustment operation refers to the operation of adjusting the display orientation of the interaction navigation panel, the display orientation of the close-range panel, and/or the display orientation of the long-range panel based on the display position of the interaction navigation panel. For example, moving the interaction navigation panel the predetermined distance towards the east direction based on the current display position of the interaction navigation panel; alternatively, moving the long-range panel the predetermined distance towards the north direction based on the current display position of the long-range panel, and the like. The predetermined distance can be flexibly set according to the user's needs, such as 0.5 m, and the present disclosure does not specifically limit the predetermined distance.

The region adjustment operation refers to the operation of adjusting the size or position of the display regions of various display modules on the interaction navigation panel, the close-range panel, and/or the long-range panel. For example, adjusting the positions of the display region corresponding to the application repository and the display region corresponding to the setting function on the interaction navigation panel shown in FIG. 2a, adjusting the display region corresponding to the application repository before the display region corresponding to the setting function, and the like.

Of course, in addition to the above adjustment operations, other adjustment operations can also be comprised, such as adjusting the display mode, and the present disclosure does not specifically limit this.

Correspondingly, adjusting the interaction navigation panel, the close-range panel, and/or the long-range panel presented in the virtual space in response to an adjustment operation on the interaction navigation panel, the close-range panel, and/or the long-range panel, specifically comprises at least one of following: if the adjustment operation is a scaling adjustment operation, performing scaling adjustment on the interaction navigation panel, the close-range panel, and/or the long-range panel based on the scaling adjustment operation; if the adjustment operation is an orientation adjustment operation, adjusting the orientation of the interaction navigation panel, the close-range panel, and/or the long-range panel based on the orientation adjustment operation; and if the adjustment operation is a region adjustment operation, performing region adjustment on the interaction navigation panel, the close-range panel, and/or the long-range panel based on the region adjustment operation.

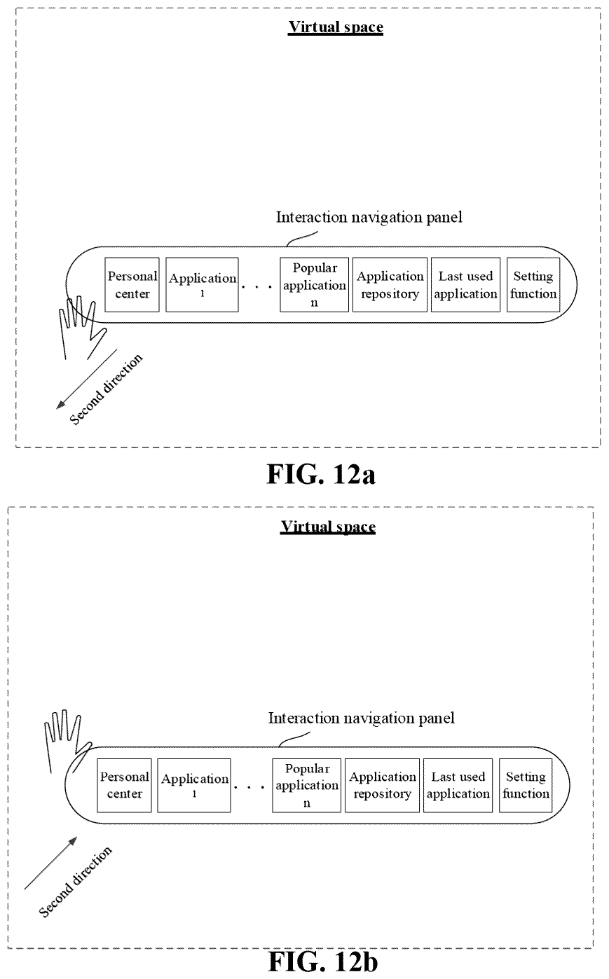

Exemplarily, as shown in FIG. 12a, the user can control the hand model to grab the bottom left corner of the interaction navigation panel and stretch the interaction navigation panel in the second direction to scale up and adjust the interaction navigation panel. Alternatively, as shown in FIG. 12b, the user can control the hand model to grab the top left corner of the interaction navigation panel and shrink the interaction navigation panel in the second direction to scale down and adjust the interaction navigation panel. Therefore, by scaling up and down the interaction navigation panel, the user can obtain an interaction navigation panel that conforms to the personal usage habit of the user, thereby meeting the personalized needs of the user.

It should be noted that after adjusting the interaction navigation panel, the close-range panel, and/or the long-range panel presented in the virtual space, the present disclosure can optionally store the adjusted interaction navigation panel, the adjusted close-range panel, and/or the adjusted long-range panel, so that when the user uses the interaction navigation panel, the close-range panel, and/or the long-range panel again subsequently, the adjusted interaction navigation panel, the adjusted close-range panel, and/or the adjusted long-range panel can be displayed in the virtual scene, to facilitate to perform the human-computer interaction operation based on the adjusted interaction navigation panel, the adjusted close-range panel, and/or the adjusted long-range panel for the user. Of course, optionally, when the user uses the interaction navigation panel, the close-range panel, and/or the long-range panel again subsequently, the interaction navigation panel, the close-range panel, and/or the long-range panel in the default mode can also be directly used, which can be selected based on the usage needs of the user, and the present disclosure does not specifically limit this.

It should be noted that when the adjusted interaction navigation panel, the adjusted close-range panel, and/or the adjusted long-range panel are displayed, the user can also adjust the adjusted interaction navigation panel, the adjusted close-range panel, and/or the adjusted long-range panel again. The specific adjustment process is similar to the above mentioned adjustment process, and will not be repeated here.

The interaction method of the virtual space provided in the embodiment of the present disclosure sets up the long-range panel, the close-range panel, and the interaction navigation panel, so that when the user interacts with the virtual space, different interaction operations are performed by using the interaction objects presented on the interaction navigation panel. Moreover, by determining whether the target display panel of the interaction page associated with the interaction object is the long-range panel or the close-range panel during interaction, the interaction page associated with the interaction object is displayed on the corresponding target display panel, and therefore, through presenting different interaction panels to the user, the interaction needs of the user in different usage scenes can be met, thereby improving the interactivity and flexibility of the user when interacting with the virtual space, and improving the user experience. In addition, in response to the adjustment operation triggered by the user, the panels presented in the virtual space are adjusted to meet the personalized needs of the user and further improve the human-computer interaction experience.

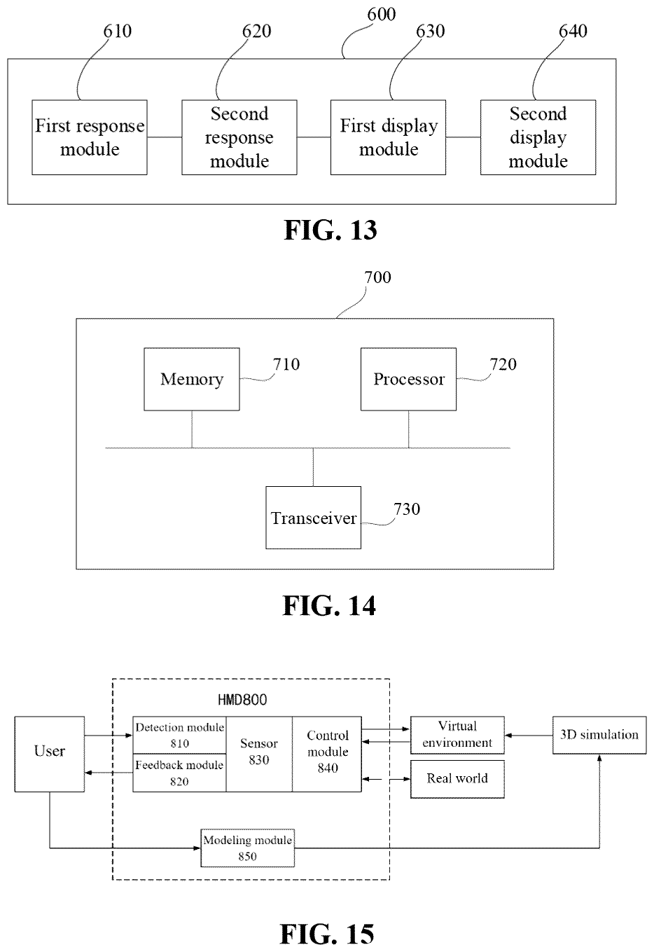

In the following, an interaction apparatus of a virtual space provided in the embodiment of the present disclosure is described with reference to FIG. 13. FIG. 13 is a schematic block diagram of an interaction apparatus of a virtual space according to the embodiment of the present disclosure.

As shown in FIG. 13, the interaction apparatus of the virtual space 600 comprises a first response module 610, a second response module 620, a first display module 630, and a second display module 640

The first response module 610 is used for presenting an interaction navigation panel in a virtual space in response to a wake-up instruction of the virtual space, the interaction navigation panel comprises at least two pending interaction objects; the second response module 620 is used for determining a target display panel of an interaction page associated with the interaction object in response to a triggering operation on an interaction object of the pending interaction objects; the first display module 630 is used for waking up a close-range panel in the virtual space and displaying the interaction page associated with the interaction object on the close-range panel if the target display panel is the close-range panel; and the second display module 640 is used for waking up a long-range panel in the virtual space and displaying the interaction page associated with the interaction object on the long-range panel if the target display panel is the long-range panel, the close-range panel and the long-range panel are configured to display independently and in different positions.

In an implementation of the embodiments of the present disclosure, the second response module 620 comprises: a type determination unit for determining a type of the interaction object; and a panel determination unit for determining the target display panel of the interaction page associated with the interaction object based on the type of the interaction object.

In an implementation of the embodiments of the present disclosure, the type determination unit is specifically used for: obtaining identification information of the interaction object; and determining the type of the interaction object based on the identification information.

In an implementation of the embodiments of the present disclosure, the panel determination unit is specifically used for: searching for the target display panel of the interaction page associated with the interaction object in a mapping relationship between an interaction object type and a display panel based on the type of the interaction object.

In an implementation method of the present disclosure embodiment, the panel determination unit is also used for: if the target display panel is not found, determining the long-range panel as the target display panel of the interaction page associated with the interaction object according to a predetermined display rule.

In an implementation of the embodiment of the present disclosure, the interaction page comprises: a first interaction control; correspondingly, the device 600 further comprises: a third response module for presenting a virtual input model in the virtual space in response to a triggering operation on the first interaction control; and an information presentation module for presenting corresponding input interaction information on the interaction page based on an input operation by a user acting on the virtual input model.

In an implementation of the embodiment of the present disclosure, the third response module is specifically used for: if the interaction page is displayed on the close-range panel, presenting a close-range virtual input model corresponding to the close-range panel in the virtual space; and if the interaction page is displayed on the long-range panel, presenting a long-range virtual input model corresponding to the long-range panel in the virtual space. The close-range virtual input model and the long-range virtual input model are displayed independently and in different positions.

In an implementation of the embodiment of the present disclosure, the information presentation module is specifically used for: displaying corresponding text and/or emoticon interaction information in an interaction region of the interaction page based on a text and/or emoticon input operation acting on the virtual input model; alternatively, scaling the virtual input model presented in the virtual space based on a scaling operation acting on the virtual input model.

In an implementation of the embodiment of the present disclosure, the virtual input model comprises an input region and a display region; correspondingly, the information presentation module is further used for: displaying the corresponding input interaction information in the display region based on an input operation by a user acting on the input region; and displaying the corresponding input interaction information on the interaction page in response to a triggering operation on a sending button in the input region.

In an implementation of the embodiment of the present disclosure, the apparatus 600 further comprises: a hidden module for hiding the interaction navigation panel presented in the virtual space.

In an implementation of the embodiment of the present disclosure, the interaction page further comprises at least one presented second interaction control; correspondingly, the apparatus 600 further comprises: a fourth response module for presenting a first prompt pop-up window associated with a second interaction control in the virtual space in response to a triggering operation on the second interaction control of the at least one presented second interaction control, the first prompt pop-up window at least comprises a confirmation sub-control and a cancellation sub-control; a fifth response module for executing an interaction operation associated with the second interaction control in response to a triggering operation on the confirmation sub-control; a sixth response module for cancelling the execution of the interaction operation associated with the second interaction control in response to a triggering operation on the cancellation sub-control.

In an implementation of the embodiment of the present disclosure, if the interaction page is displayed on the close-range panel, the fourth response module is further used for: displaying the first prompt pop-up window associated with the second interaction control at a first predetermined position between the close-range panel and the interaction navigation panel presented in the virtual space.

In an implementation of the embodiment of the present disclosure, if the interaction page is displayed on the long-range panel, the fourth response module is further used for: displaying the first prompt pop-up window associated with the second interaction control at a second predetermined position between the long-range panel and the interaction navigation panel presented in the virtual space.

In an implementation of the embodiment of the present disclosure, the apparatus 600 further comprises: a first display module for waking up the long-range panel in the virtual space and displaying the interaction page associated with the other interaction object on the long-range panel if any other interaction object in the interaction navigation panel is detected to be triggered and the target display panel of the interaction page associated with the other interaction object is the long-range panel.

In an implementation of the embodiment of the present disclosure, the apparatus 600 further comprises: a second display module for waking up the close-range panel in the virtual space and displaying the interaction page associated with the other interaction object on the close-range panel if any other interaction object in the interaction navigation panel is detected to be triggered and the target display panel of the interaction page associated with the other interaction object is the close-range panel.

In an implementation of the embodiment of the present disclosure, the apparatus 600 further comprises: a third display module for displaying a second prompt pop-up window in the virtual space, and the second prompt pop-up window is displayed in front of the close-range panel.

In an implementation of the embodiment of the present disclosure, the third response module is used for executing at least one of the following: displaying a security zone setting prompt pop-up window in the virtual space in response to a detection of a security zone setting instruction; displaying an authentication prompt pop-up window in the virtual space in response to a detection of an authentication instruction; and displaying a power prompt pop-up window in the virtual space upon battery power being detected to be lower than a predetermined threshold.

In an implementation of the embodiment of the present disclosure, the apparatus 600 further comprises: a seventh response module for adjusting the interaction navigation panel, the close-range panel, and/or the long-range panel presented in the virtual space in response to an adjustment operation on the interaction navigation panel, the close-range panel, and/or the long-range panel.

In an implementation of the embodiment of the present disclosure, the seventh response module is specifically used for: if the adjustment operation is a scaling adjustment operation, performing scaling adjustment on the interaction navigation panel, the close-range panel, and/or the long-range panel based on the scaling adjustment operation; if the adjustment operation is an orientation adjustment operation, adjusting the orientation of the interaction navigation panel, the close-range panel, and/or the long-range panel based on the orientation adjustment operation; and if the adjustment operation is a region adjustment operation, performing region adjustment on the interaction navigation panel, the close-range panel, and/or the long-range panel based on the region adjustment operation.

The interaction apparatus of the virtual space provided in the embodiment of the present disclosure sets up the long-range panel, the close-range panel, and the interaction navigation panel, so that when the user interacts with the virtual space, different interaction operations are performed by using the interaction objects presented on the interaction navigation panel. Moreover, by determining whether the target display panel of the interaction page associated with the interaction object is the long-range panel or the close-range panel during interaction, the interaction page associated with the interaction object is displayed on the corresponding target display panel, and therefore, through presenting different interaction panels to the user, the interaction needs of the user in different usage scenes can be met, thereby improving the interactivity and flexibility of the user when interacting with the virtual space, and improving the user experience.

It should be understood that the embodiment of the apparatus and the embodiment of the method can correspond to each other, and similar descriptions can refer to the embodiment of the method, and to avoid repetition, is not repeated here again. Specifically, the device 600 shown in FIG. 13 can execute the embodiments of the method corresponding to FIG. 1, and the aforementioned and other operations and/or functions of each module in the device 600 are respectively designed to implement the corresponding processes of each method in FIG. 1. For simplicity, it will not be repeated here.

The device 600 of the embodiments of the present disclosure is described from the perspective of the functional module in conjunction with the drawings. It should be understood that the functional module can be implemented through hardware, software instructions, or a combination of hardware and software modules. Specifically, the steps of the method embodiment in the first aspect in the embodiments of the present disclosure may be accomplished by the integrated logic circuit of hardware in the processor and/or the instruction in the form of software. The steps of the method in the first aspect disclosed in conjunction with the embodiments of the present disclosure may be directly performed by a hardware decoding processor, or performed by combining hardware and software modules in a decoding processor. Optionally, the software module may be located in a random memory, a flash memory, a read-only memory, a programmable read-only memory, an electrically erasable programmable memory, a register, and other mature storage media in the art. The storage medium is located in the memory, and the processor reads the information in the memory to complete the steps in the above embodiment of the first aspect method in combination with its hardware.

FIG. 14 is a schematic block diagram of an electronic device according to the embodiment of the present disclosure. As shown in FIG. 14, the electronic device 700 can comprise: a memory 710 and a processor 720. The memory 710 is used to store the computer program and transfer the program code to the processor 720. In other words, the processor 720 can call and run the computer program from the memory 710 to achieve the interaction method of the virtual space in the embodiments of the present disclosure.

For example, the processor 720 can be used to execute the embodiment of the aforementioned interaction method of the virtual space based on the instruction in the computer program.

In some embodiments of the present disclosure, the processor 720 may comprise but is not limited to: a general-purpose processor, a digital signal processor (DSP), an application specific integrated circuit (ASIC), a field programmable gate arrays (FPGA), or other programmable logic devices, discrete gate or transistor logic devices, discrete hardware components, and the like.

In some embodiments of the present disclosure, the memory 710 comprises but is not limited to: a volatile memory and/or a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), which is used as an external cache. By way of illustration but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct Rambus RAM (DR RAM).

In some embodiments of the present disclosure, the computer program may be divided into one or more modules, which are stored in the memory 710 and executed by the processor 720 to complete the interaction method of the virtual space provided in the present disclosure. The one or more modules can be a series of computer program instruction segments capable of completing a specific function, and the instruction segments are used to describe the execution process of the computer program in the electronic device.

As shown in FIG. 14, the electronic device 700 can further comprise: a transceiver 730, which may be connected to the processor 720 or the memory 710.

The processor 720 can control the transceiver 730 to communicate with other devices, specifically, sending information or data to other devices, or receiving information or data sent by the other devices. The transceiver 730 may comprise a transmitter and a receiver. The transceiver 730 may further comprise antennas, and the number of antennas can be one or more.

It should be understood that the various components in the electronic device are connected through a bus system, which comprises a power bus, a control bus, and a status signal bus, in addition to a data bus.

In the embodiment of the present disclosure, when the electronic device is an HMD, the embodiment of the present disclosure provides a schematic block diagram of an HMD, as shown in FIG. 15.

As shown in FIG. 15, the main functional modules of the HMD 800 may comprise but are not limited to the following: a detection module 810, a feedback module 820, a sensor 830, a control module 840, and a modeling module 850.

The detection module 810 is configured to detect the operation commands of the user using various sensors and act on the virtual environment, such as continuously updating the images displayed on the display screen to follow the user's line of sight, thus achieving the interaction between the user and the virtual scene.

The feedback module 820 is configured to receive data from the sensor and provide real-time feedback to the user. For example, the feedback module 820 can generate a feedback instruction based on the operation data of the user and output the feedback instruction.

The sensor 830 is configured, on one hand, to receive the operation command from the user and apply the operation command to the virtual environment; and, on the other hand, to provide the result generated after the operation to the user in the form of various feedbacks.

The control module 840 is configured to control the sensors and various input/output devices, comprising obtaining data from the user such as movement, voice, and outputting perception data such as images, vibrations, temperature, sound, and the like, to act on the user, the virtual environment, and the real world. For example, the control module 640 may obtain the user's gestures, voice, and the like.

The modeling module 850 is configured to construct a three-dimensional model of the virtual environment, and may also comprise various feedback mechanisms such as sound, touch, and the like in the three-dimensional model.

It should be understood that the various functional modules in the HMD 800 are connected through a bus system, which comprises a power bus, a control bus, a status signal bus, and the like, in addition to a data bus.

The present disclosure also provides a computer storage medium on which a computer program is stored, and when the computer program is executed by the computer, it enables the computer to execute the interaction method of the virtual space provided by the embodiments of the above method.

The embodiment of the present disclosure also provides a computer program product including a program instruction, when the program instruction is run on the electronic device, causing the electronic device to execute the interaction method of the virtual space provided by the embodiments of the above method.

When implemented using software, it may be fully or partially implemented in the form of the computer program product. The computer program product comprises one or more computer instructions. When loading and executing the computer program instruction on the computer, all or part of the processes or functions according to the embodiments of the present disclosure are generated. The computer may be a general-purpose computer, a specialized computer, a computer network, or other programmable devices. The computer instruction may be stored in the computer-readable storage medium or transmitted from one computer-readable storage medium to another, for example, the computer instruction can be transmitted from a web site site, a computer, a server, or a data center through the wired method (e.g., coaxial cable, fiber optic, digital subscriber line (DSL)) or the wireless method (e.g., infrared, wireless, microwave, etc.) to another website site, computer, server, or data center. The computer-readable storage medium may be any available medium that the computer can access, or a data storage device such as a server or data center that contains one or more available medium. The available medium may be a magnetic medium (e.g., a floppy disk, a hard disk, a magnetic tape), an optical medium (e.g., a digital video disc (DVD)), or a semiconductor medium (e.g., a solid-state disk (SSD), etc.), and the like.

Those skilled in the art can appreciate that the modules and algorithm steps of the examples described in conjunction with the embodiments disclosed herein can be implemented by electronic hardware, or a combination of computer software and electronic hardware. Whether these functions are executed by hardware or software depends on the specific application and design constraints of the technical solution. Professional technician may use different methods to implement the described functions for each specific application, but such implementation should not be considered beyond the scope of the present disclosure.

In the several embodiments provided in the present disclosure, it should be understood that the systems, apparatuses, and methods disclosed, may be implemented in other ways. For example, the embodiments of the apparatus described above are only illustrative. For example, the division of the modules is only a logical function division, there may be other division approaches in actual implementation, for example, a plurality of modules or components may be combined or may be integrated into another system, or some features may be ignored, or not implemented. In another point, the mutual coupling or direct coupling or communication connection shown or discussed may be indirect coupling or communication connection through some interfaces, devices or modules, and may be in electrical, mechanical or other forms.

The module illustrated as a separated component may or may not be physically separated, and a component displayed as a module may or may not be a physical module, that is, it may be located in one place, or may also be distributed to multiple network units. Part or all of the modules can be selected according to actual needs to achieve the purpose of the solution of the embodiment. For example, various functional modules in various embodiments of the present disclosure may be integrated into one processing module, each module may exist separately physically, or two or more modules may be integrated into one module.

What are described above is related to the specific embodiments of the present disclosure only, and the scope of the present disclosure is not limited to this. Anyone skilled in the art can easily think of changes or substitutions within the scope of the technology disclosed in the present disclosure, which should be covered within the protection scope of the present disclosure. Therefore, the scopes of the present disclosure are defined by the accompanying claims.

1. An interaction method of a virtual space, comprising:
presenting an interaction navigation panel in the virtual space in response to a wake-up instruction of the virtual space, wherein the interaction navigation panel comprises at least two pending interaction objects;
in response to a triggering operation on an interaction object of the pending interaction objects, determining a target display panel of an interaction page associated with the interaction object;
if the target display panel is a close-range panel, waking up the close-range panel in the virtual space and displaying the interaction page associated with the interaction object on the close-range panel; and
if the target display panel is a long-range panel, waking up the long-range panel in the virtual space and displaying the interaction page associated with the interaction object on the long-range panel,
wherein the close-range panel and the long-range panel are configured to display independently and in different positions.

2. The method according to claim 1, wherein the determining the target display panel of the interaction page associated with the interaction object comprises:
determining a type of the interaction object; and
determining the target display panel of the interaction page associated with the interaction object based on the type of the interaction object.

3. The method according to claim 2, wherein the determining the type of the interaction object, comprises:
obtaining identification information of the interaction object; and
determining the type of the interaction object based on the identification information.

4. The method according to claim 2, wherein the determining the target display panel of the interaction page associated with the interaction object based on the type of the interaction object, comprises:
searching for the target display panel of the interaction page associated with the interaction object in a mapping relationship between an interaction object type and a display panel based on the type of the interaction object.

5. The method according to claim 4, further comprising:
if the target display panel is not found, determining the long-range panel as the target display panel of the interaction page associated with the interaction object according to a predetermined display rule.

6. The method according to claim 1, wherein the interaction page comprises a first interaction control, and the method further comprises:
presenting a virtual input model in the virtual space in response to a triggering operation on the first interaction control; and
presenting corresponding input interaction information on the interaction page based on an input operation by a user acting on the virtual input model.

7. The method according to claim 6, wherein the presenting the virtual input model in the virtual space, comprises:
if the interaction page is displayed on the close-range panel, presenting a close-range virtual input model corresponding to the close-range panel in the virtual space; and
if the interaction page is displayed on the long-range panel, presenting a long-range virtual input model corresponding to the long-range panel in the virtual space,
wherein the close-range virtual input model and the long-range virtual input model are displayed independently and in different positions.

8. The method according to claim 6, wherein the presenting the corresponding input interaction information on the interaction page based on the input operation by the user acting on the virtual input model, comprises:
displaying corresponding text and/or emoticon interaction information in an interaction region of the interaction page based on a text and/or emoticon input operation acting on the virtual input model;
alternatively,
scaling the virtual input model presented in the virtual space based on a scaling operation acting on the virtual input model.

9. The method according to claim 6, wherein the virtual input model comprises an input region and a display region;
the presenting the corresponding input interaction information on the interaction page based on the input operation by the user acting on the virtual input model, comprises:
displaying the corresponding input interaction information in the display region based on an input operation by the user acting on the input region; and
displaying the corresponding input interaction information on the interaction page in response to a triggering operation on a sending button in the input region.

10. The method of claim 6, wherein before the presenting the virtual input model in the virtual space, the method further comprises:
hiding the interaction navigation panel presented in the virtual space.

11. The method according to claim 1, wherein the interaction page further comprises at least one presented second interaction control; and
the method further comprises:
in response to a triggering operation on a second interaction control of the at least one presented second interaction control, presenting a first prompt pop-up window associated with the second interaction control in the virtual space, wherein the first prompt pop-up window at least comprises a confirmation sub-control and a cancellation sub-control;
executing an interaction operation associated with the second interaction control in response to a triggering operation on the confirmation sub-control; and
cancelling execution of the interaction operation associated with the second interaction control in response to a triggering operation on the cancellation sub-control.

12. The method according to claim 7, wherein if the interaction page is displayed on the close-range panel, the presenting the first prompt pop-up window associated with the second interaction control in the virtual space, comprises:
displaying the first prompt pop-up window associated with the second interaction control at a first predetermined position between the close-range panel and the interaction navigation panel presented in the virtual space; and
if the interaction page is displayed on the long-range panel, the presenting the first prompt pop-up window associated with the second interaction control in the virtual space, comprises:
displaying the first prompt pop-up window associated with the second interaction control at a second predetermined position between the long-range panel and the interaction navigation panel presented in the virtual space.

13. The method according to claim 1, wherein after displaying the interaction page associated with the interaction object on the close-range panel, the method further comprises:
if any other interaction object in the interaction navigation panel is detected to be triggered and a target display panel of an interaction page associated with the other interaction object is the long-range panel, waking up the long-range panel in the virtual space and displaying the interaction page associated with the other interaction object on the long-range panel.

14. The method according to claim 1 wherein after displaying the interaction page associated with the interaction object on the long-range panel, the method further comprises:
if any other interaction object in the interaction navigation panel is detected to be triggered and a target display panel of an interaction page associated with the other interaction object is the close-range panel, waking up the close-range panel in the virtual space and displaying the interaction page associated with the other interaction object on the close-range panel.

15. The method according to claim 1, further comprising:
displaying a second prompt pop-up window in the virtual space,
wherein the second prompt pop-up window is displayed in front of the close-range panel.

16. The method according to claim 15, wherein the displaying the second prompt pop-up window in the virtual space, comprises at least one of the following:
displaying a security zone setting prompt pop-up window in the virtual space in response to a detection of a security zone setting instruction;
displaying an authentication prompt pop-up window in the virtual space in response to a detection of an authentication instruction; and
displaying a power prompt pop-up window in the virtual space upon battery power being detected to be lower than a predetermined threshold.

17. The method according to claim 1, further comprising:
adjusting the interaction navigation panel, the close-range panel, and/or the long-range panel presented in the virtual space in response to an adjustment operation on the interaction navigation panel, the close-range panel, and/or the long-range panel,
wherein the adjusting the interaction navigation panel, the close-range panel, and/or the long-range panel presented in the virtual space, comprises:
if the adjustment operation is a scaling adjustment operation, performing scaling adjustment on the interaction navigation panel, the close-range panel, and/or the long-range panel based on the scaling adjustment operation;
if the adjustment operation is an orientation adjustment operation, adjusting an orientation of the interaction navigation panel, the close-range panel, and/or the long-range panel based on the orientation adjustment operation; and
if the adjustment operation is a region adjustment operation, performing region adjustment on the interaction navigation panel, the close-range panel, and/or the long-range panel based on the region adjustment operation.

18. An interaction apparatus of a virtual space, comprising:
a first response module for presenting an interaction navigation panel in the virtual space in response to a wake-up instruction of the virtual space, wherein the interaction navigation panel comprises at least two pending interaction objects;
a second response module for determining a target display panel of an interaction page associated with an interaction object in response to a triggering operation on the interaction object of the pending interaction objects;
a first display module for waking up a close-range panel in the virtual space and displaying the interaction page associated with the interaction object on the close-range panel if the target display panel is the close-range panel;
a second display module for waking up a long-range panel in the virtual space and displaying the interaction page associated with the interaction object on the long-range panel if the target display panel is the long-range panel; and
wherein the close-range panel and the long-range panel are configured to be displayed independently and in different positions.

19. An electronic device, comprising:
a processor and a memory,
wherein the memory is used to store computer programs, and the processor is used to call and run the computer programs stored in the memory to execute an interaction method of a virtual space,
wherein the interaction method of the virtual space comprises:
presenting an interaction navigation panel in the virtual space in response to a wake-up instruction of the virtual space, wherein the interaction navigation panel comprises at least two pending interaction objects;
in response to a triggering operation on an interaction object of the pending interaction objects, determining a target display panel of an interaction page associated with the interaction object;
if the target display panel is a close-range panel, waking up the close-range panel in the virtual space and displaying the interaction page associated with the interaction object on the close-range panel; and
if the target display panel is a long-range panel, waking up the long-range panel in the virtual space and displaying the interaction page associated with the interaction object on the long-range panel,
wherein the close-range panel and the long-range panel are configured to display independently and in different positions.

20. A computer-readable storage medium for storing computer programs which cause a computer to execute the interaction method of the virtual space according to claim 1.
